(19) United States
(12) Patent Application Publication
(10) Pub. No.: US 2026/0322447 A1
(43) Pub. Date: Oct. 15, 2026

(54) BEAM PAIR REPORTING FOR PREDICTED BEAM MEASUREMENTS

(71) Applicant: QUALCOMM Incorporated, San Diego, CA (US)

(72) Inventors: Qiaoyu LI, Beijing (CN); Arumugam CHENDAMARAI KANNAN, San Diego, CA (US); Tao LUO, San Diego, CA (US); Mahmoud TAHERZADEH BOROUJENI, San Diego, CA (US)

(21) Appl. No.: 19/108,575

(22) PCT Filed: Nov. 1, 2022
(86) PCT No.: PCT/CN2022/128911

§ 371 Date: Mar. 4, 2025

(51) Int. Cl. H04B 7/06

(52) U.S. Cl. CPC H04B 7/0626; H04B 7/06952

(57) ABSTRACT

Various aspects of the present disclosure generally relate to wireless communication. In some aspects, a user equipment (UE) may receive, from a network node, an indication to transmit a channel state information (CSI) report associated with one or more channel measurement resources. The UE may transmit, to the network node, the CSI report including an indication of information associated with one or more receive beams that are associated with respective channel measurement resources from the one or more channel measurement resources for one or more future time domain occasions, the information including at least one of: one or more parameters associated with identifying the one or more receive beams, or an indication of the one or more receive beams. Numerous other aspects are provided.

### FIELD OF THE DISCLOSURE

Aspects of the present disclosure generally relate to wireless communication and specifically, to techniques and apparatuses associated with beam pair reporting for predicted beam measurements.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

In some examples, a user equipment (UE) and/or a network node may utilize artificial intelligence (AI) and/or machine learning (ML) (AI/ML) to facilitate one or more wireless communication functions. For example, an AI/ML model may be deployed at, or on, a UE. The AI/ML model may enable the UE to determine one or more inferences or predictions based on data input to the AI/ML model. For example, the AI/ML model may be trained to output predicted beam measurements based on one or more actual beam measurements that are provided as an input to the AI/ML model. In some examples, an output of the AI/ML model may include predicted measurement values for a set of channel measurement resources (CMRs) associated with a future measurement occasion. An input to the AI/ML model may include measurement values (for example, that are measured by the UE or predicted by the UE using the AI/ML model) for a given measurement occasion and receive beam information for a next measurement occasion (for example, a receive beam to be associated with a given CMR in a next measurement occasion after the given measurement occasion).

The input to the AI/ML model for receive beam information may include N measurement value indications along with N indications of receive beam information (for example, a receive beam identifier), where N is a quantity of CMRs configured for the UE (for example, configured for a channel state information (CSI) report). In some example, each indication of receive beam information may include a vector having a size M, where M is a quantity of receive beams associated with the UE. For example, the vector may include M bits corresponding to respective receive beams from the M receive beams associated with the UE. Therefore, an input to the AI/ML model to indicate the receive beam information may be associated with a dimension of M×N. For example, M may be 64 and N may be 16, resulting in an input dimension size of 1,024 (for example, 1024 bits based on 64×16=1024). Additionally, inputs associated with the measurement values for the set of CMRs may increase the overall input size or dimension for the AI/ML model.

Increasing an input dimension size for the AI/ML model may increase the complexity and/or processing overhead associated with the AI/ML model. Therefore, increasing a quantity of receive beams associated with a UE may significantly increase a complexity and/or processing overhead associated with the UE using the AI/ML model to predict measurement values. In some cases, the AI/ML model may be deployed at a network node (for example, to reduce a computing complexity at the UE). However, different UEs may be associated with different radio frequency (RF) front end components and/or configurations (for example, different UEs may be associated with different quantities of receive beams, different placement or quantity of antenna modules, and/or may perform beamforming differently). Therefore, the network node may be unable to identify and/or select receive beams for a given UE to be used as an input to the AI/ML model.

### SUMMARY

Some aspects described herein relate to a user equipment (UE) for wireless communication. The UE may include at least one memory and at least one processor communicatively coupled with the at least one memory. The at least one processor may be operable to cause the UE to receive, from a network node, an indication to transmit a channel state information (CSI) report associated with one or more channel measurement resources. The at least one processor may be operable to cause the UE to transmit, to the network node, the CSI report including an indication of information associated with one or more receive beams that are associated with respective channel measurement resources from the one or more channel measurement resources for one or more future time domain occasions, the information including at least one of: one or more parameters associated with identifying the one or more receive beams, or an indication of the one or more receive beams.

Some aspects described herein relate to a network node for wireless communication. The network node may include at least one memory and at least one processor communicatively coupled with the at least one memory. The at least one processor may be operable to cause the network node to transmit an indication for a UE to transmit a CSI report associated with one or more channel measurement resources. The at least one processor may be operable to cause the network node to receive the CSI report, associated with the UE, including an indication of information associated with one or more receive beams, associated with the UE, that are associated with respective channel measurement resources from the one or more channel measurement resources for one or more future time domain occasions, the information including at least one of: one or more parameters associated with identifying the one or more receive beams, or an indication of the one or more receive beams.

Some aspects described herein relate to a method of wireless communication performed by a UE. The method may include receiving, from a network node, an indication to transmit a CSI report associated with one or more channel measurement resources. The method may include transmitting, to the network node, the CSI report including an indication of information associated with one or more receive beams that are associated with respective channel measurement resources from the one or more channel measurement resources for one or more future time domain occasions, the information including at least one of: one or more parameters associated with identifying the one or more receive beams, or an indication of the one or more receive beams.

Some aspects described herein relate to a method of wireless communication performed by a network node. The method may include transmitting an indication for a UE to transmit a CSI report associated with one or more channel measurement resources. The method may include receiving the CSI report, associated with the UE, including an indication of information associated with one or more receive beams, associated with the UE, that are associated with respective channel measurement resources from the one or more channel measurement resources for one or more future time domain occasions, the information including at least one of: one or more parameters associated with identifying the one or more receive beams, or an indication of the one or more receive beams.

Some aspects described herein relate to a non-transitory computer-readable medium that stores a set of instructions for wireless communication by a UE. The set of instructions, when executed by one or more processors of the UE, may cause the UE to receive, from a network node, an indication to transmit a CSI report associated with one or more channel measurement resources. The set of instructions, when executed by one or more processors of the UE, may cause the UE to transmit, to the network node, the CSI report including an indication of information associated with one or more receive beams that are associated with respective channel measurement resources from the one or more channel measurement resources for one or more future time domain occasions, the information including at least one of: one or more parameters associated with identifying the one or more receive beams, or an indication of the one or more receive beams.

Some aspects described herein relate to a non-transitory computer-readable medium that stores a set of instructions for wireless communication by a network node. The set of instructions, when executed by one or more processors of the network node, may cause the network node to transmit an indication for a UE to transmit a CSI report associated with one or more channel measurement resources. The set of instructions, when executed by one or more processors of the network node, may cause the network node to receive the CSI report, associated with the UE, including an indication of information associated with one or more receive beams, associated with the UE, that are associated with respective channel measurement resources from the one or more channel measurement resources for one or more future time domain occasions, the information including at least one of: one or more parameters associated with identifying the one or more receive beams, or an indication of the one or more receive beams.

Some aspects described herein relate to an apparatus for wireless communication. The apparatus may include means for receiving, from a network node, an indication to transmit a CSI report associated with one or more channel measurement resources. The apparatus may include means for transmitting, to the network node, the CSI report including an indication of information associated with one or more receive beams that are associated with respective channel measurement resources from the one or more channel measurement resources for one or more future time domain occasions, the information including at least one of: one or more parameters associated with identifying the one or more receive beams, or an indication of the one or more receive beams.

Some aspects described herein relate to an apparatus for wireless communication. The apparatus may include means for transmitting an indication for a UE to transmit a CSI report associated with one or more channel measurement resources. The apparatus may include means for receiving the CSI report, associated with the UE, including an indication of information associated with one or more receive beams, associated with the UE, that are associated with respective channel measurement resources from the one or more channel measurement resources for one or more future time domain occasions, the information including at least one of: one or more parameters associated with identifying the one or more receive beams, or an indication of the one or more receive beams.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram illustrating an example disaggregated base station architecture in accordance with the present disclosure.

FIG. 4 is a diagram illustrating an example architecture of a functional framework for radio access network (RAN) intelligence enabled by data collection in accordance with the present disclosure.

FIG. 5 is a diagram illustrating an example of an artificial intelligence (AI) and/or machine learning (ML) (AI/ML) based beam management in accordance with the present disclosure.

FIG. 6 is a diagram illustrating an example of inputs for AI/ML based beam management in accordance with the present disclosure.

FIG. 7 is a diagram of an example associated with beam pair reporting for predicted beam measurements in accordance with the present disclosure.

FIG. 8 is a diagram of an example associated with beam pair reporting for predicted beam measurements in accordance with the present disclosure.

FIG. 9 is a flowchart illustrating an example process performed, for example, by a UE that supports beam pair reporting for predicted beam measurements in accordance with the present disclosure.

FIG. 10 is a flowchart illustrating an example process performed, for example, by a network node that supports beam pair reporting for predicted beam measurements in accordance with the present disclosure.

FIG. 11 is a diagram of an example apparatus for wireless communication that supports beam pair reporting for predicted beam measurements in accordance with the present disclosure.

FIG. 12 is a diagram of an example apparatus for wireless communication that supports beam pair reporting for predicted beam measurements in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to beam pair reporting for predicted beam measurements. Some aspects more specifically relate to a user equipment (UE) transmitting, to a network node, an indication of information associated with one or more receive beams that are associated with respective channel measurement resources (CMRs) from a set of configured CMRs (for example, where a beam pair includes a combination of a given receive beam and a given CMR (or a beam associated with the given CMR)). In some aspects, the UE may receive, from the network node, a request for a channel state information (CSI) report that is associated with multiple CMRs (for example, the set of CMRs). The UE may transmit, and the network node may receive, the CSI report, where the CSI report includes the information associated with the one or more receive beams (also referred to herein as “receive beam information”). The receive beam information may include identifiers of the one or more receive beams associated with respective CMRs. Additionally or alternatively, the information associated with one or more receive beams may include one or more parameters associated with identifying the one or more receive beams. The one or more parameters may indicate information to enable the network node to identify the one or more receive beams. For example, the one or more parameters may include a location of one or more antenna modules (for example, on the UE), an orientation of the one or more antenna modules, codebook information, an automatic gain control operation status, and/or one or more thermal parameters, among other examples.

In some aspects, the CSI report may also include an indication or indications of one or more measurement values associated with at least one of the CMRs from the set of CMRs. The network node may input pairings of receive beams with respective CMRs into an artificial intelligence (AI) and/or machine learning (ML) (AI/ML) model that is trained to predict beam measurements (for example, to predict beam measurements as would otherwise be measured by the UE). In some aspects, the information associated with one or more receive beams may be associated with a future time domain occasion (for example, a future measurement occasion). In other words, the receive beams may be receive beams that are selected by the UE for measuring and/or predicting measurement values for the respective CMRs at the future time domain occasion.

Particular aspects of the subject matter described in this disclosure can be implemented to realize one or more of the following potential advantages. In some examples, the described techniques can be used to eliminate or mitigate the need for an increased complexity and/or processing overhead that would have otherwise been required by a UE to predict measurement values for a set of CMRs. For example, by transmitting an indication of one or more receive beams to a network node, the network node is able to identify inputs to be provided to the AI/ML model. This may enable the network node to deploy the AI/ML model for predicting measurement values associated with the UE (for example, using receive beam information associated with the UE). As a result, the network node may obtain predicted beam measurements associated with the UE (for example, using receive beam information associated with the UE) while also conserving processing resources and/or power resources of the UE that would have otherwise been used by the UE to predict the beam measurements.

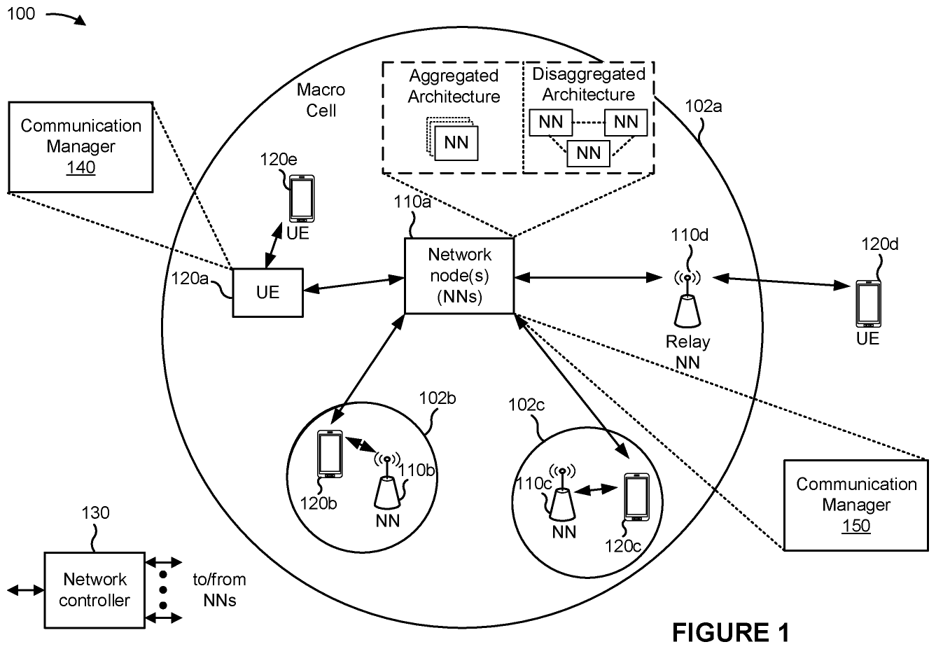

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, and/or a RAN node. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), and/or a Non-Real Time (Non-RT) RIC. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

In some examples, a cell may not necessarily be stationary, and the geographic area of the cell may move in accordance with the location of a network node 110 that is mobile (for example, a mobile network node). In some examples, the network nodes 110 may be interconnected to one another or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IOT) devices, or may be implemented as NB-IOT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). Although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz 300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHZ), FR4 (52.6 GHz-114.25 GHZ), and FR5 (114.25 GHz-300 GHz). Each of these higher frequency bands falls within the EHF band.

With the above examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive, from a network node, an indication to transmit a CSI report associated with one or more channel measurement resources; and transmit, to the network node, the CSI report including an indication of information associated with one or more receive beams that are associated with respective channel measurement resources from the one or more channel measurement resources for one or more future time domain occasions, the information including at least one of: one or more parameters associated with identifying the one or more receive beams, or an indication of the one or more receive beams. Additionally or alternatively, the communication manager 140 may perform one or more other operations described herein.

In some aspects, the network node 110 may include a communication manager 150. As described in more detail elsewhere herein, the communication manager 150 may transmit an indication for a UE to transmit a CSI report associated with one or more channel measurement resources; and receive the CSI report, associated with the UE, including an indication of information associated with one or more receive beams, associated with the UE, that are associated with respective channel measurement resources from the one or more channel measurement resources for one or more future time domain occasions, the information including at least one of: one or more parameters associated with identifying the one or more receive beams, or an indication of the one or more receive beams. Additionally or alternatively, the communication manager 150 may perform one or more other operations described herein.

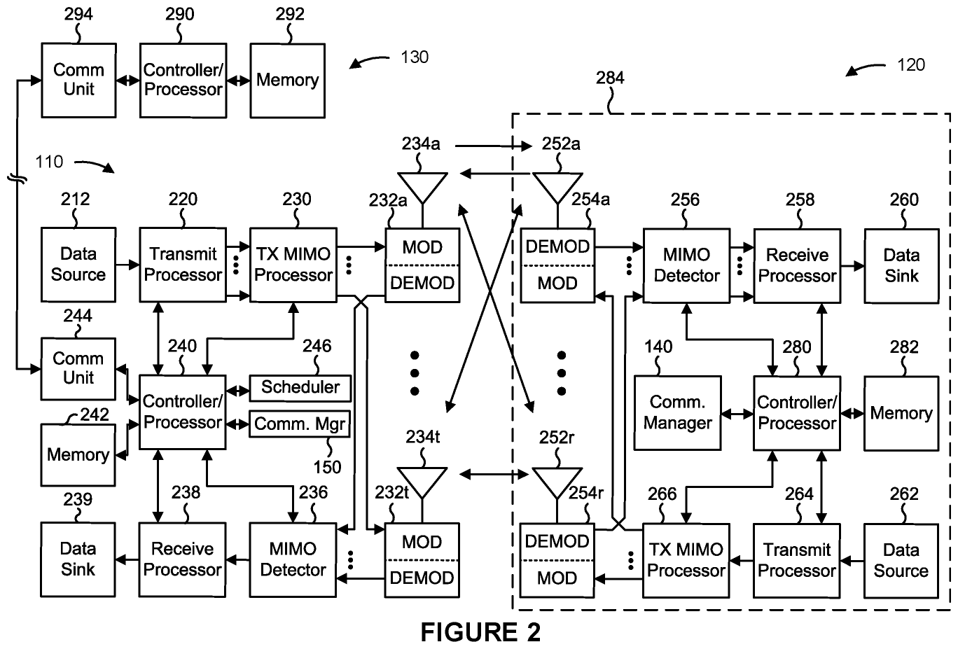

FIG. 2 is a diagram illustrating an example network node in communication with a UE in a wireless network in accordance with the present disclosure. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers and/or one or more processors. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

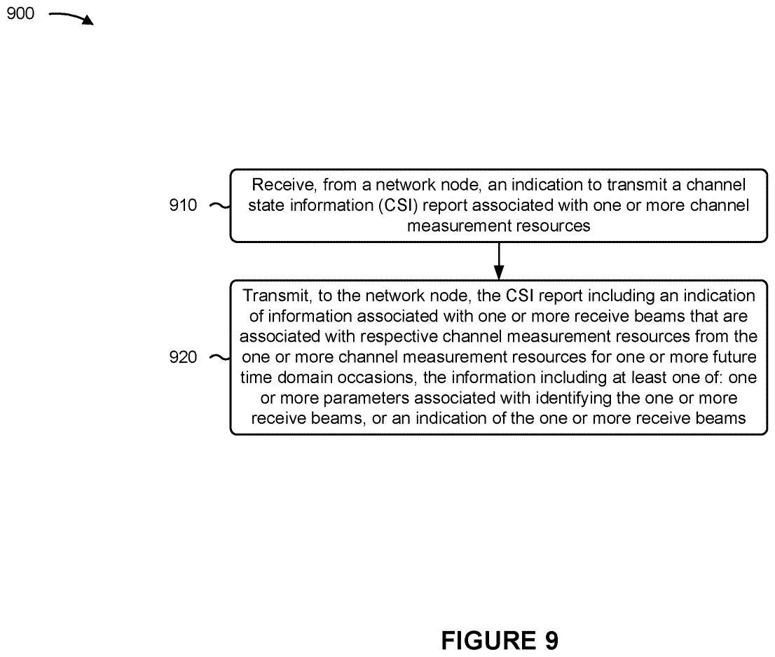

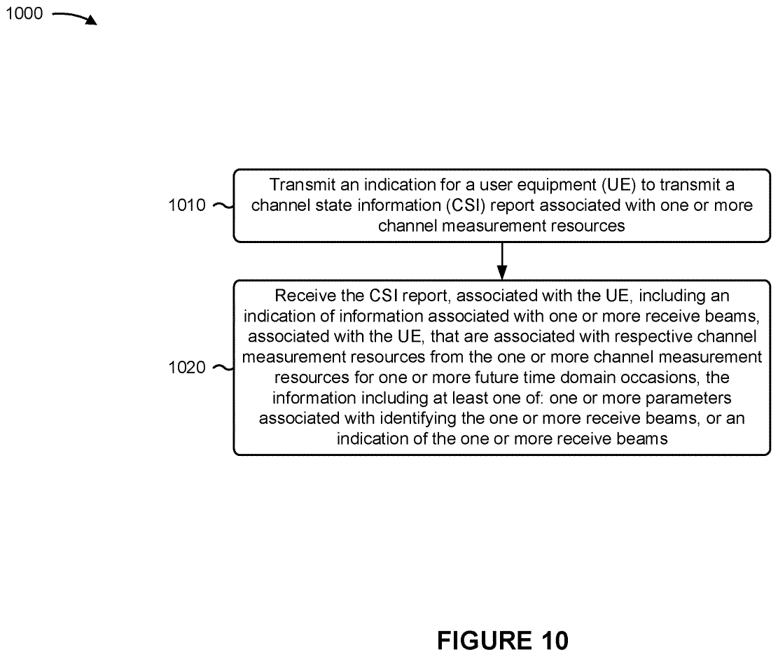

The controller/processor 240 of the network node 110, the controller/processor 280 of the UE 120, or any other component(s) of FIG. 2 may perform one or more techniques associated with beam pair reporting for predicted beam measurements, as described in more detail elsewhere herein. For example, the controller/processor 240 of the network node 110, the controller/processor 280 of the UE 120, or any other component(s) of FIG. 2 may perform or direct operations of, for example, process 900 of FIG. 9, process 1000 of FIG. 10, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 900 of FIG. 9, process 1000 of FIG. 10, or other processes as described herein. In some examples, executing instructions may include running the instructions, converting the instructions, compiling the instructions, or interpreting the instructions, among other examples.

In some aspects, the UE 120 includes means for receiving, from a network node, an indication to transmit a CSI report associated with one or more channel measurement resources; and/or means for transmitting, to the network node, the CSI report including an indication of information associated with one or more receive beams that are associated with respective channel measurement resources from the one or more channel measurement resources for one or more future time domain occasions, the information including at least one of: one or more parameters associated with identifying the one or more receive beams, or an indication of the one or more receive beams. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting an indication for a UE to transmit a CSI report associated with one or more channel measurement resources; and/or means for receiving the CSI report, associated with the UE, including an indication of information associated with one or more receive beams, associated with the UE, that are associated with respective channel measurement resources from the one or more channel measurement resources for one or more future time domain occasions, the information including at least one of: one or more parameters associated with identifying the one or more receive beams, or an indication of the one or more receive beams. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, and/or one or more RUs).

An aggregated base station (for example, an aggregated network node) may be configured to utilize a radio protocol stack that is physically or logically integrated within a single RAN node (for example, within a single device or unit). A disaggregated base station (for example, a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

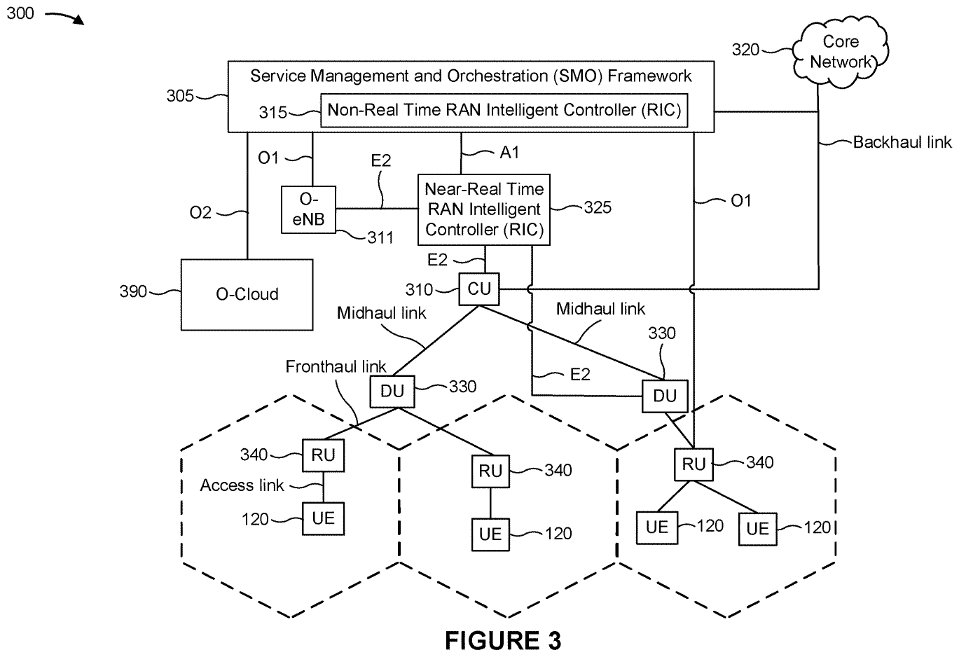

FIG. 3 is a diagram illustrating an example disaggregated base station architecture 300 in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), and/or control plane functionality (for example, Central Unit-Control Plane (CU-CP) functionality). In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an Ol interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an Ol interface) or via creation of RAN management policies (such as A1 interface policies).

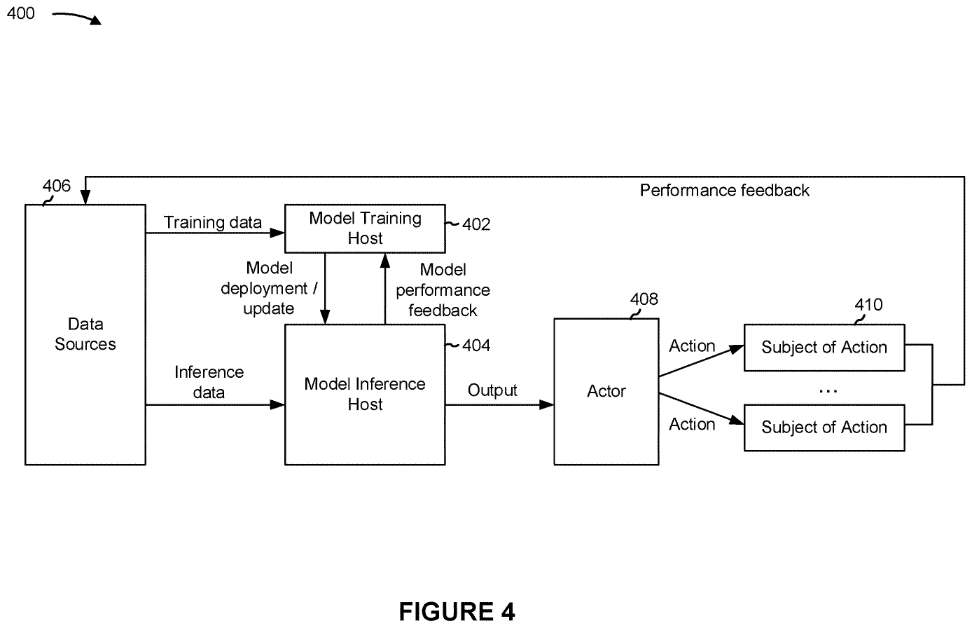

FIG. 4 is a diagram illustrating an example architecture 400 of a functional framework for radio access network (RAN) intelligence enabled by data collection in accordance with the present disclosure. In some scenarios, the functional framework for RAN intelligence may be enabled by further enhancement of data collection through use cases and/or examples. For example, principles or algorithms for RAN intelligence enabled by AI/ML and the associated functional framework (for example, the AI functionality and/or the input/output of the component for AI enabled optimization) have been utilized or studied to identify the benefits of AI enabled RAN through possible use cases (for example, beam management, energy saving, load balancing, mobility management, and/or coverage optimization, among other examples). In one example, as shown by the architecture 400, a functional framework for RAN intelligence may include multiple logical entities, such as a model training host 402, a model inference host 404, data sources 406, and an actor 408.

The model inference host 404 may be configured to run an AI/ML model based on inference data provided by the data sources 406, and the model inference host 404 may produce an output (for example, a prediction) with the inference data input to the actor 408. The actor 408 may be an element or an entity of a core network or a RAN. For example, the actor 408 may be a UE, a network node, base station (for example, a gNB), a CU, a DU, and/or an RU, among other examples. In addition, the actor 408 may also depend on the type of tasks performed by the model inference host 404, type of inference data provided to the model inference host 404, and/or type of output produced by the model inference host 404. For example, if the output from the model inference host 404 is associated with beam management, then the actor 408 may be a UE, a DU or an RU. In other examples, if the output from the model inference host 404 is associated with Tx/Rx scheduling, then the actor 408 may be a CU or a DU.

After the actor 408 receives an output from the model inference host 404, the actor 408 may determine whether to act based on the output. For example, if the actor 408 is a DU or an RU and the output from the model inference host 404 is associated with beam management, the actor 408 may determine whether to change/modify a Tx/Rx beam based on the output. If the actor 408 determines to act based on the output, the actor 408 may indicate the action to at least one subject of action 410. For example, if the actor 408 determines to change/modify a Tx/Rx beam for a communication between the actor 408 and the subject of action 410 (for example, a UE 120), then the actor 408 may transmit a beam (re-)configuration or a beam switching indication to the subject of action 410. The actor 408 may modify its Tx/Rx beam based on the beam (re-)configuration, such as switching to a new Tx/Rx beam or applying different parameters for a Tx/Rx beam, among other examples. As another example, the actor 408 may be a UE and the output from the model inference host 404 may be associated with beam management. For example, the output may be one or more predicted measurement values for one or more beams. The actor 408 (for example, a UE) may determine that a measurement report (for example, a Layer 1 (L1) RSRP report) is to be transmitted to a network node 110.

The data sources 406 may also be configured for collecting data that is used as training data for training an ML model or as inference data for feeding an ML model inference operation. For example, the data sources 406 may collect data from one or more core network and/or RAN entities, which may include the subject of action 410, and provide the collected data to the model training host 402 for ML model training. For example, after a subject of action 410 (for example, a UE 120) receives a beam configuration from the actor 408, the subject of action 410 may provide performance feedback associated with the beam configuration to the data sources 406, where the performance feedback may be used by the model training host 402 for monitoring or evaluating the ML model performance, such as whether the output (for example, prediction) provided to the actor 408 is accurate. In some examples, if the output provided by the actor 408 is inaccurate (or the accuracy is below an accuracy threshold), then the model training host 402 may determine to modify or retrain the ML model used by the model inference host, such as via an ML model deployment/update.

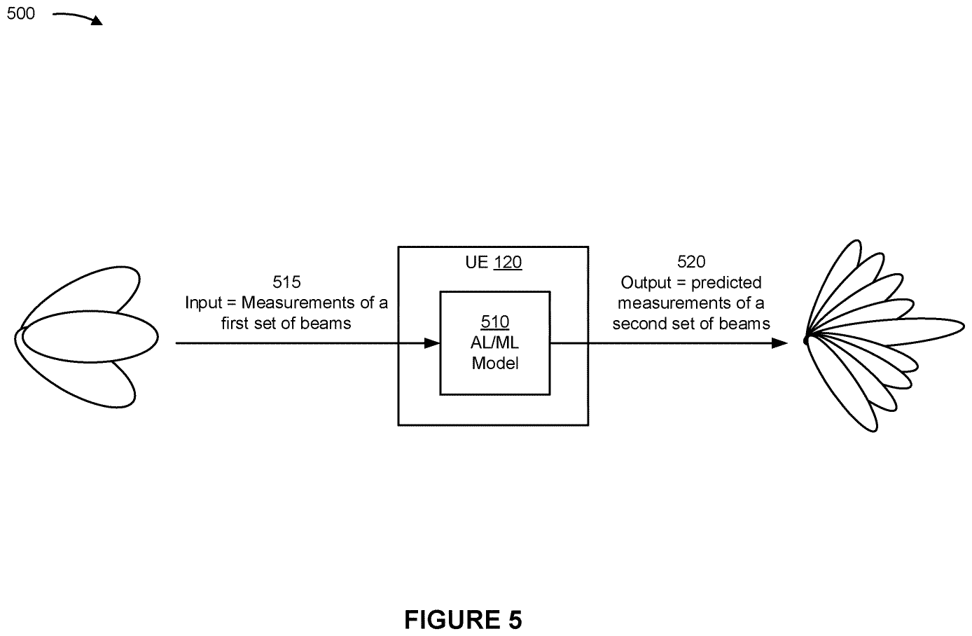

FIG. 5 is a diagram illustrating an example of an AI/ML based beam management 500 in accordance with the present disclosure. As shown in FIG. 5, an AI/ML model 510 may be deployed at or on a UE 120. For example, a model inference host (such as a model inference host) may be deployed at, or on, a UE 120. The AI/ML model 510 may enable the UE 120 to determine one or more inferences or predictions based on data input to the AI/ML model 510.

The AI/ML model 510 may include a neural network model or a neural network function. The neural network model or the neural network function may be trained to output Y based on an input X. For example, as described elsewhere herein, the input X may be measurement values (for example, RSRP measurement values) of one or more beams. The output Y may be predicted measurement values (for example, predicted future measurement values) of the one or more beams and/or of one or more other beams. The neural network may be defined as a model structure and a parameter set. The model structure may include a type of neural network (for example, a convolutional neural network, a recurrent neural network, a feedforward neural network, a modular neural network, and/or another type of neural network), a quantity of layers associated with the neural network, and/or other architectural parameters associated with the neural network. The model structure may be associated with a model structure identifier. The model structure identifier may be a unique identifier (for example, in a wireless network) to enable network nodes, UEs, or other devices to identify the model structure. The model structure may be linked to, or associated with, the neural network function. The neural network function may be linked to, or associated with, the AI/ML model 510. In some examples, the AI/ML model 510 may include, or be associated with, multiple model structures. In some examples, the AI/ML model 510 may include a recurrent neural network, such as a long short-term memory (LSTM) neural network, among other examples.

In some examples, the AI/ML model 510 may be deployed or executed by a network node 110. For example, the network node 110 may train and/or configure the AI/ML model 510 (for example, may select a model structure and/or identify a parameter set). The network node 110 may receive, from a UE 120, one or more measurements associated with a first set of beams. The network node 110 may provide the one or more measurements as an input to the AI/ML model 510. An output of the AI/ML model 510 may include predicted measurement values associated with the first set of beams and/or predicted measurement values associated with a second set of beams. In other examples, the AI/ML model 510 may be deployed or executed by a UE 120. For example, a network node 110 may train and/or configure the AI/ML model 510. The network node 110 may transmit, and the UE 120 may receive, a configuration of the AI/ML model 510 (for example, may receive an indication of a model structure and a parameter set).

For example, in a first operation 515, an input to the AI/ML model 510 may include measurements associated with a first set of beams. For example, a network node 110 may transmit one or more signals using respective beams from the first set of beams. The UE 120 may perform measurements (for example, L1 RSRP measurements or other measurements) of the first set of beams to obtain a first set of measurements. For example, each beam, from the first set of beams, may be associated with one or more measurements performed by the UE 120. The UE 120 may input the first set of measurements (for example, L1 RSRP measurement values) into the AI/ML model 510 along with information associated with the first set of beams and/or a second set of beams, such as a beam direction (for example, spatial direction), beam width, beam shape, and/or other characteristics of the respective beams from the first set of beams and/or the second set of beams.

In a second operation 520, the AI/ML model 510 may output one or more predictions. The one or more predictions may include predicted measurement values (for example, predicted L1 RSRP measurement values) associated with the first set of beams and/or with the second set of beams. For example, the first set of beams and the second set of beams may be the same set of beams, may include one or more common beams, or may be mutually exclusive sets of beams This may reduce a quantity of beam measurements that are performed by the UE 120, thereby conversing power of the UE 120 and/or network resources that would have otherwise been used to measure all beams included in the first set of beams and the second set of beams. This type of prediction may be referred to as a codebook based spatial domain selection or prediction. In examples where the first set of beams and the second set of beams are the same set of beams, the prediction may be referred to as a time domain selection or prediction.

As another example, an output of the AI/ML model 510 may include a point-direction, an angle of departure (AoD), and/or an angle of arrival (AoA) of a beam included in the second set of beams. This type of prediction may be referred to as a non-codebook based spatial domain selection or prediction. As another example, multiple measurement report or values, collected at different points in time, may be input to the AI/ML model 510. This may enable the AI/ML model 510 to output codebook based and/or non-codebook based predictions for a measurement value, an AoD, and/or an AoA, among other examples, of a beam at a future time. The output(s) of the AI/ML model 510, as described herein, may facilitate initial access procedures, secondary cell group (SCG) setup procedures, beam refinement procedures (for example, a P2 beam management procedure or a P3 beam management procedure), link quality or interference adaptation procedure, beam failure and/or beam blockage predictions, and/or radio link failure predictions, among other examples.

In some examples, the first set of beams may be referred to as Set B beams and the second set of beams may be referred to as Set A beams. In some examples, the first set of beams (for example, the Set B beams) may be a subset of the second set of beams (for example, the Set A beams). In some other examples, the first set of beams and the second set of beams may be different beams and/or may be mutually exclusive sets. For example, the first set of beams (for example, the Set B beams) may include wide beams (for example, unrefined beams or beams having a beam width that satisfies a first threshold) and the second set of beams (for example, the Set A beams) may include narrow beams (for example, refined beams or beams having a beam width that satisfies a second threshold). In one example, the AI/ML model 510 may perform spatial-domain downlink beam predictions for beams included in the Set A beams based on measurement results of beams included in the Set B beams. As another example, the AI/ML model 510 may perform temporal downlink beam prediction for beams included in the Set A beams based on historic measurement results of beams included in the Set B beams.

In some examples, a measurement value that is reported to a network node 110 (for example, by a UE 120) may be associated with a channel measurement resource (CMR). A CMR may be a resource that is configured for a UE 120 for performing measurements of a channel. In some examples, a CMR may include a synchronization signal block (SSB) and/or a channel state information (CSI) reference signal (CSI-RS) (for example, a non-zero power CSI-RS (NZP-CSI-RS)), among other examples. For example, a CMR may be configured with a periodicity at which the CMR is to be transmitted and/or measured (for example, a CMR may be configured with a measurement periodicity of 20 milliseconds indicating that the UE 120 is to measure the CMR every 20 milliseconds). At a given measurement occasion (for example, a time at which the UE 120 is performing a measurement) for a given CMR, the UE 120 may select a receive beam of the UE 120 to be used to measure the CMR (for example, from M receive beams associated with the UE 120). The UE 120 may select the receive beam based on one or more observations performed by the UE 120, such as previous filtered measurements and/or previous receive beams used by the UE 120, among other examples. In some examples, the UE 120 may use an AI/ML model to select the receive beam. The measurement obtained from measuring the CMR using the receive beam may be a measurement for a beam pair that includes a beam associated with the CMR (for example, a transmit beam of a network node 110 associated with the CMR) and the receive beam. The measurement may be referred to as an instantaneous measurement (for example, an instantaneous RSRP measurement).

The UE 120 may calculate a filtered RSRP value for a given CMR. The filtered RSRP value may indicate an estimated best measurement value (for example, an estimated best RSRP) associated with an estimated best receive beam of the UE 120. The UE 120 may calculate the filtered RSRP value based on instantaneous measurements of the given CMR (for example, associated with different receive beams) over a previous one or more measurement occasions. The UE 120 may transmit, to a network node 110, a measurement report indicating one or more highest filtered measurement values calculated by the UE 120. For example, the UE 120 may indicate the one or more highest filtered measurement values along with respective CMR identifiers of CMRs associated with the one or more highest filtered measurement values. The UE 120 may not include information associated with the receive beams used by the UE 120 in the measurement report. In other words, the UE 120 may not indicate receive beam codebook implementation information to the network node 110. Rather, the UE 120 may store an indication of the receive beam(s) associated with respective CMRs and may use the receive beam(s) to measure the CMRs and/or downlink signals that have a quasi co-location (QCL) relationship with the CMRs.

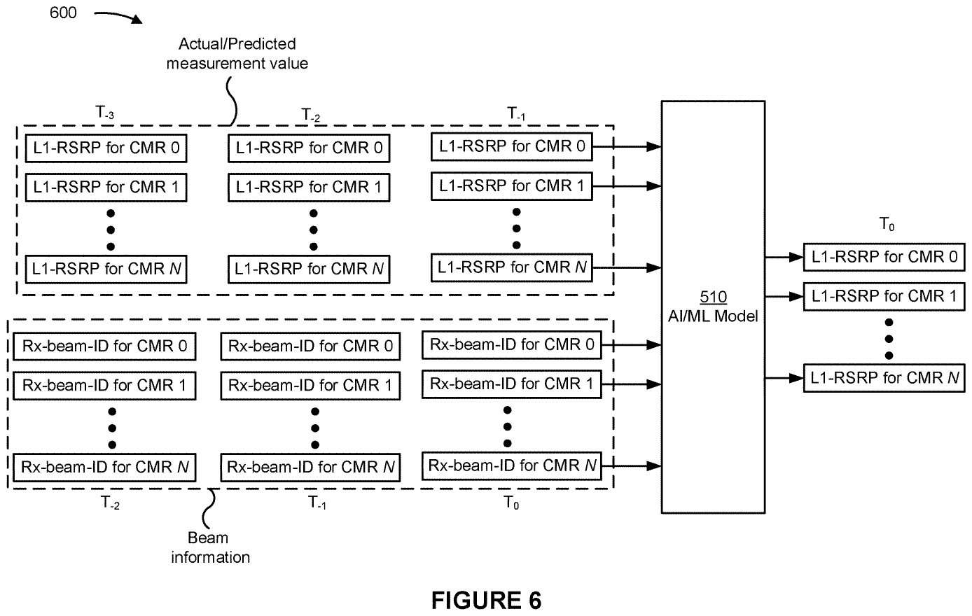

FIG. 6 is a diagram illustrating an example of inputs 600 for AI/ML based beam management in accordance with the present disclosure. As described elsewhere herein, a UE 120 may calculate a filtered RSRP value for a given CMR based on measuring a measurement value (for example, an L1-RSRP value) for the given CMR over one or more measurement occasions (for example, using different receive beams of the UE 120). In some examples, to predict measurement values (for example, filtered measurement values or instantaneous measurement values) at a given measurement occasion for one or more CMRs, an input to an AI/ML model (for example, the AI/ML model 510) may include previous measurement values (for example, actually measured measurement values or previously predicted measurement values) along with receive beam information (for example, a receive beam to be associated with a CMR for which the UE 120 is predicting a measurement value).

For example, as shown in FIG. 6, an output of the AI/ML model 510 may include predicted measurement values (for example, predicted L1-RSRP measurement values) for a set of CMRs (for example, CMR 0 through CMR N) at a given measurement occasion (for example, T₀). An input to the AI/ML model 510 may include different sets of information. Each set of information may include measurement values (for example, that are measured by the UE 120 or predicted by the UE 120 using the AI/ML model 510) for a given measurement occasion and receive beam information for a next measurement occasion (for example, a receive beam to be associated with a given CMR in a next measurement occasion). The receive beams may be receive beams that are actually used by the UE 120 to measure a given CMR or may be receive beams that are selected by the UE 120 but not actually used to measure the given CMR (for example, where the UE 120 predicts a measurement value of the given CMR rather than actually measuring the given CMR). As used herein, a receive beam that is selected by the UE 120 but not actually used to measure a given CMR may be referred to as a “virtual” receive beam. As an example input to the AI/ML model 510, a first set of information may include measurement values for the set of CMRs for a measurement occasion T₋₃ and receive beam information associated with a measurement occasion T₋₂. A second set of information may include measurement values for the set of CMRs for the measurement occasion T₋₂ and receive beam information associated with a measurement occasion T₋₁. A third set of information may include measurement values for the set of CMRs for the measurement occasion T₋₁ and receive beam information associated with the measurement occasion T₀. The AI/ML model 510 may output the predicted measurement values (for example, predicted L1-RSRP measurement values) for the set of CMRs for the measurement occasion To based on the inputs to the AI/ML model 510.

As shown in FIG. 6, the input (for example, each set of information) may include N measurement value indications along with N indications of receive beam information (for example, a receive beam identifier). In some examples, each indication of receive beam information may be a vector having a size M, where M is a quantity of receive beams associated with the UE 120. For example, the vector may be a one-hot vector (for example, a group of bits among which the permitted combinations of values are only those with a single high (1) bit and all the others low (0), where the single high (1) bit is associated with the receive beam to be indicated by the one-hot vector) or a one-cold vector (for example, a group of bits among which the permitted combinations of values are only those with a single low (0) bit and all the others high (1), where the single low (0) bit is associated with the receive beam to be indicated by the one-cold vector). For example, the vector may include M bits corresponding to respective receive beams from the M receive beams associated with the UE 120. Therefore, an input to the AI/ML model 510 to indicate the receive beam information may be associated with a dimension of M×N. For example, M may be 64 (for example, a UE 120 may be associated with 64 receive beams) and N may be 16 (for example, 16 CMRs may be configured for the UE 120), resulting in an input dimension size of 1,024 (for example, 1024 bits based on 64×16=1024). Additionally, inputs associated with the measurement values for the set of CMRs may increase the overall input size or dimension for the AI/ML model 510.

Increasing an input dimension size for the AI/ML model 510 may increase the complexity and/or processing overhead associated with the AI/ML model 510. Therefore, increasing a quantity of receive beams associated with a UE 120 may significantly increase a complexity and/or processing overhead associated with the UE 120 using the AI/ML model 510 to predict measurement values. In some cases, the AI/ML model 510 may be deployed at a network node (for example, to reduce a computing complexity at the UE 120). However, different UEs may be associated with different RF front end components and/or configurations (for example, different UEs may be associated with different quantities of receive beams, different placement or quantities of antenna modules, and/or may perform beamforming differently). Therefore, the network node may be unable to identify and/or select receive beams for a given UE to be used as an input to the AI/ML model 510.

Various aspects relate generally to beam pair reporting for predicted beam measurements. Some aspects more specifically relate to a user equipment (UE) transmitting, to a network node, an indication of information associated with one or more receive beams that are associated with respective channel measurement resources (CMRs) from a set of configured CMRs (for example, where a beam pair includes a combination of a given receive beam and a given CMR (or a beam associated with the given CMR)). In some aspects, the UE may receive, from the network node, a request for a channel state information (CSI) report that is associated with multiple CMRs (for example, the set of CMRs). The UE may transmit, and the network node may receive, the CSI report, where the CSI report includes the information associated with the one or more receive beams (also referred to herein as “receive beam information”). The receive beam information may include identifiers of the one or more receive beams associated with respective CMRs. Additionally or alternatively, the information associated with one or more receive beams may include one or more parameters associated with identifying the one or more receive beams. The one or more parameters may indicate information to enable the network node to identify the one or more receive beams. For example, the one or more parameters may include a location of one or more antenna modules (for example, on the UE), an orientation of the one or more antenna modules, codebook information, an automatic gain control operation status, and/or one or more thermal parameters, among other examples.

In some aspects, the CSI report may also include an indication or indications of one or more measurement values associated with at least one of the CMRs from the set of CMRs. The network node may input pairings of receive beams with respective CMRs into an artificial intelligence (AI) and/or machine learning (ML) (AI/ML) model that is trained to predict beam measurements (for example, to predict beam measurements as would otherwise be measured by the UE). In some aspects, the information associated with one or more receive beams may be associated with a future time domain occasion (for example, a future measurement occasion). In other words, the receive beams may be receive beams that are selected by the UE for measuring and/or predicting measurement values for the respective CMRs at the future time domain occasion.

Particular aspects of the subject matter described in this disclosure can be implemented to realize one or more of the following potential advantages. In some examples, the described techniques can be used to eliminate or mitigate the need for an increased complexity and/or processing overhead that would have otherwise been required by a UE to predict measurement values for a set of CMRs. For example, by transmitting an indication of one or more receive beams to a network node, the network node is able to identify inputs to be provided to the AI/ML model. This may enable the network node to deploy the AI/ML model for predicting measurement values associated with the UE (for example, using receive beam information associated with the UE). As a result, the network node may obtain predicted beam measurements associated with the UE (for example, using receive beam information associated with the UE) while also conserving processing resources and/or power resources of the UE that would have otherwise been used by the UE to predict the beam measurements.

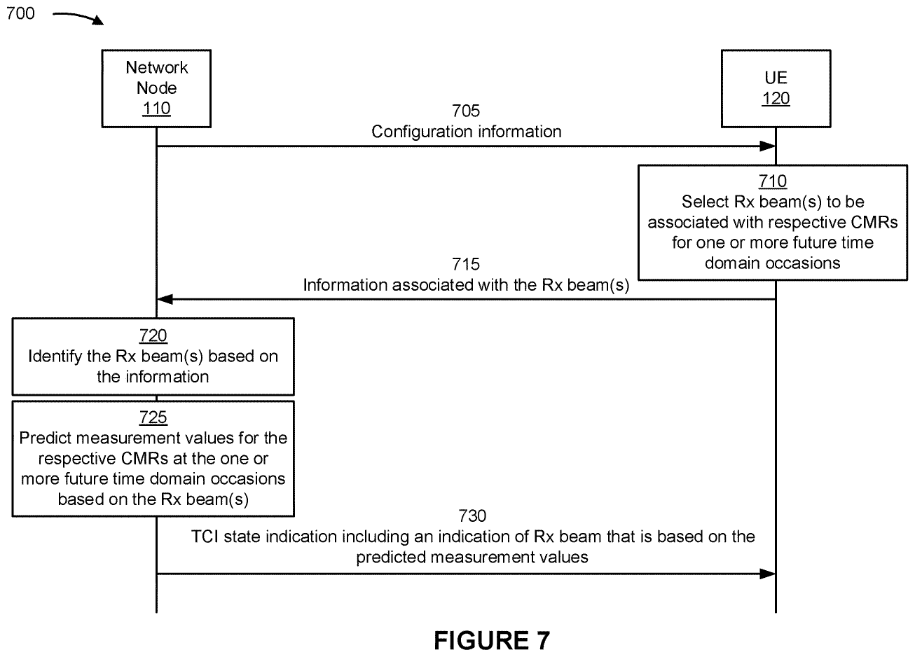

FIG. 7 is a diagram of an example associated with beam pair reporting for predicted beam measurements 700 in accordance with the present disclosure. As shown in FIG. 7, a network node 110 (for example, a base station, a CU, a DU, and/or an RU) may communicate with a UE 120. In some aspects, the network node 110 and the UE 120 may be part of a wireless network (for example, the wireless network 100). The UE 120 and the network node 110 may have established a wireless connection prior to operations shown in FIG. 7.

In some aspects, actions described herein as being performed by the network node 110 may be performed by multiple different network nodes. For example, configuration actions may be performed by a first network node (for example, a CU or a DU), and radio communication actions may be performed by a second network node (for example, a DU or an RU). As used herein, the network node 110 “transmitting” a communication to the UE 120 may refer to a direct transmission (for example, from the network node 110 to the UE 120) or an indirect transmission via one or more other network nodes or devices. For example, if the network node 110 is a DU, an indirect transmission to the UE 120 may include the DU transmitting a communication to an RU and the RU transmitting the communication to the UE 120. Similarly, the UE 120 “transmitting” a communication to the network node 110 may refer to a direct transmission (for example, from the UE 120 to the network node 110) or an indirect transmission via one or more other network nodes or devices. For example, if the network node 110 is a DU, an indirect transmission to the network node 110 may include the UE 120 transmitting a communication to an RU and the RU transmitting the communication to the DU.

In some aspects, the UE 120 may transmit, and the network node 110 may receive, a capability report. The capability report may indicate UE support for reporting receive beam information of the UE 120 to the network node 110. For example, the capability report may indicate that the UE 120 supports transmitting an indication of one or more receive beams of the UE 120 to the network node 110 (for example, to facilitate beam predictions performed by the network node 110, as described in more detail elsewhere herein). In some aspects, the capability report may indicate that the UE 120 supports transmitting an indication of one or more receive beams of the UE 120 that are selected, for respective CMRs of a set of configured CMRs, for one or more future time domain occasions or measurement occasions. For example, the capability report may indicate that the UE 120 supports transmitting an indication of virtual receive beams (for example, that are selected or identified by the UE 120 but that are not actually used by the UE 120). In some aspects, the UE 120 may be configured to report the indication of selected receive beams for respective CMRs (for example, as described in more detail elsewhere herein) based at least in part on the capability report (for example, based at least in part on the capability report indicating that the UE 120 supports transmitting an indication of one or more receive beams of the UE 120 that are selected, for respective CMRs of a set of configured CMRs).

In a first operation 705, the network node may transmit, and the UE may receive, configuration information. In some aspects, the UE may receive the configuration information via one or more of system information signaling, RRC signaling, one or more MAC control elements (MAC-CEs), and/or downlink control information (DCI), among other examples. In some aspects, the configuration information may include an indication of one or more configuration parameters (for example, stored by the UE 120 and/or previously indicated by the network node 110 or other network device) for selection by the UE 120, and/or explicit configuration information for the UE 120 to use to configure itself, among other examples.

In some aspects, the configuration information may indicate that the UE 120 is to transmit a CSI report associated with one or more CMRs. For example, the network node 110 may transmit, and the UE 120 may receive, an indication to transmit a CSI report associated with the one or more CMRs. For example, the configuration information may include a CSI configuration. For example, the CSI configuration may include a CSI report configuration (for example, a CSI reporting setting or a CSI-ReportConfig) indicating CMRs to be associated with the CSI report configuration. For example, the CSI report configuration may include identifiers for respective CMRs that are associated with the CSI report configuration (for example, in a csi-ResourceConfigId field or a resourcesForChannelMeasurement field). In some aspects, the CMRs may be CSI-RSs, SSBs, and/or other downlink reference signals. In some aspects, the configuration information may include configurations of respective CMRs.

In some aspects, the configuration information may indicate that the UE 120 is to include information associated with receive beams in the CSI report. For example, the configuration information may indicate that the UE 120 is to transmit an indication of receive beams selected by the UE 120, to be associated with respective CMRs from the set of CMRs, for one or more future measurement occasions. In other words, the configuration information may indicate a request from the network node 110 for receive beams associated with beam pairs to be used by the network node 110 to perform beam measurement predictions (for example, in a similar manner as described in more detail elsewhere herein). As used herein, a beam pair may include a receive beam (for example, of the UE 120) and a transmit beam associated with a CMR (for example, a transmit beam of the network node 110). The configuration information may indicate that the UE 120 is to transmit information associated with receive beams associated with respective CMRs to enable the network node 110 to provide the receive beams as inputs to an AI/ML model that is trained to predict measurement values for CMRs (for example, such as the AI/ML model 510).

In some aspects, the configuration information may indicate a type of information for receive beams that is to be reported by the UE 120. For example, the configuration information may indicate that the UE 120 is to report an indication of the one or more receive beams (for example, indicating that the UE 120 is to directly report the receive beams associated with respective CMRs). Additionally or alternatively, the configuration information may indicate that the UE 120 is to report one or more parameters (for example, UE local observations) associated with identifying the one or more receive beams. For example, the one or more parameters may include a location of one or more antenna modules (for example, on the UE 120), an orientation of the one or more antenna modules, codebook information, an automatic gain control operation status, and/or one or more thermal parameters, among other examples. As another example, the one or more parameters may include a random seed value that is to be used as an input to an AI/ML model (for example, that is trained to output an indication of the one or more receive beams based on receiving an input of the random seed value).

In some aspects, the configuration information may indicate that the CSI report is to include the indication of the one or more receive beams and an indication of one or more measurement values associated with at least one CMR from the set of CMRs. For example, the configuration information may indicate that the CSI report is to include the indication of the one or more receive beams (for example, selected by the UE 120 to be associated with respective CMRs for a future time domain occasion) and an indication of one or more measurement values measured by the UE 120 at a previous time domain occasion.

The UE 120 may configure itself based at least in part on the configuration information. For example, the UE 120 may be configured to perform one or more operations described herein based at least in part on the configuration information.

In a second operation 710, the UE 120 may select one or more receive beams associated with respective CMRs from the one or more CMRs associated with the CSI report. For example, the UE 120 may select a receive beam to be associated with a given CMR from the one or more CMRs. The UE 120 may select a receive beam for each CMR included in the one or more CMRs. The UE 120 may select the one or more receive beams based at least in part on one or more observations performed by the UE 120, such as previous filtered measurements and/or previous receive beams used by the UE 120, among other examples. In some examples, the UE 120 may use an AI/ML model to select the one or more receive beams. For example, the UE 120 may select a receive beam for a CMR, where the selected receive beam is virtually selected by the UE 120 for an upcoming or future time domain occasion or measurement occasion. In other words, a selected receive beam may be a receive beam that would be used by the UE 120 to measure the CMR in the upcoming or future time domain occasion or measurement occasion. The selected receive beam(s) may be virtual receive beams in that the UE 120 may not use the receive beam(s) to measure the respective CMRs. Rather, the UE 120 may identify and/or select the receive beams to facilitate beam measurement predictions performed by the network node 110, as described in more detail elsewhere herein.

In a third operation 715, the UE 120 may transmit, and the network node 110 may receive, an indication of information associated with the one or more receive beams that are associated with respective CMRs from the one or more CMRs (for example, information associated with the receive beams selected by the UE 120 in the second operation 710). For example, the UE 120 may transmit, and the network node 110 may receive, an indication of information associated with one or more receive beams that are associated with respective CMRs from the one or more configured CMRs (for example, configured as part of the first operation 705). In some aspects, for each CMR, the UE 120 may transmit an indication of a receive beam that is associated with a CMR for one or more future time domain occasions (for example, for one or more future measurement occasions).

In some aspects, the indication of information associated with the one or more receive beams may be included in an RRC communication. For example, in some aspects, the UE 120 may transmit, and the network node 110 may receive, a CSI report. The CSI report may include the information associated with the one or more receive beams that are associated with respective CMRs from the one or more CMRs. Additionally or alternatively, the UE 120 may transmit, and the network node 110 may receive, a MAC-CE communication that includes the information associated with the one or more receive beams. For example, the UE 120 may transmit an RRC communication indicating a first one or more parameters associated with identifying the one or more receive beams. The UE 120 may transmit one or more MAC-CE communications indicating a second one or more parameters associated with identifying the one or more receive beams. For example, the RRC communication may indicate parameters that do not change over time (for example, static parameters). The one or more MAC-CE communications may indicate parameters that may change over time.

In some aspects, the one or more receive beams include one or more beams used by the UE to receive at least one CMR from the one or more CMRs, and/or a virtual beam that is predicted to be associated with at least one CMR from the one or more CMRs. In some aspects, the UE 120 may transmit an indication of the receive beams selected by the UE 120. For example, the UE 120 may transmit identifiers associated with respective receive beams (for example, along with an identifier of a CMR associated with each receive beam). Additionally or alternatively, the UE 120 may transmit an indication of one or more parameters associated with identifying the one or more receive beams. For example, the one or more parameters may indicate information to be used by the network node 110 to identify and/or derive the one or more receive beams (for example, to derive a spatial direction and/or a beam width associated with respective receive beams). The one or more parameters may be local observations at the UE 120 to be used as inputs to determine the one or more receive beams. For example, the one or more parameters may include a location of one or more antenna modules (for example, on the UE 120), an orientation of the one or more antenna modules, codebook information (for example, spatial directions, beam pointing directions, and/or beam widths), an automatic gain control operation status, and/or one or more thermal parameters, among other examples. For example, the automatic gain control operation status may indicate a dynamic range of an allowed input power associated with signals received by the UE 120. Certain beams may be associated with a higher input power than other beams (for example, narrow beams may be associated with a higher input power than wide beams). Therefore, the automatic gain control operation status may indicate a type or subset of beams available for selection by the UE 120 and/or the network node 110. Similarly, the UE 120 may be associated with one or more thermal parameters indicating a thermal requirement of the UE 120. Certain beams may be associated with additional antenna elements (for example, that generate heat when in operation). Therefore, the one or more thermal parameters may indicate a type or subset of beams available for selection by the UE 120 and/or the network node 110.

As described elsewhere herein, the UE 120 may transmit an indication of a first one or more parameters in an RRC communication. For example, the codebook information, the location of one or more antenna modules, and/or the orientation of the one or more antenna module, among other examples, may be static information (for example, that does not change over time) and may be indicated by the UE 120 in an RRC communication. A second one or more parameters may be included in a MAC-CE communication. For example, the automatic gain control operation status and/or the one or more thermal parameters may vary (for example, slightly) over time. Therefore, the UE 120 may use a MAC-CE communication to indicate changes or updates to the second one or more parameters.

In some aspects, the UE 120 may transmit, and the network node 110 may receive, an indication that an update to at least one of the parameters is to be reported to the network node 110. For example, the UE 120 may transmit, and the network node 110 may receive, uplink control information (UCI) indicating that an update to at least one of the parameters is to be reported to the network node 110. For example, the UCI may be included in the CSI report. The UE 120 may receive scheduling information for the MAC-CE communication based at least in part on transmitting the UCI. For example, if no uplink grant is available for the UE 120, then the indication in the UCI may be interpreted by the network node 110 as a request for uplink scheduling (for example, to schedule the UE 120 to transmit the MAC-CE communication).

In some aspects, the one or more parameters may include one or more random seed values. For example, the one or more random seed values may be associated with identifying the one or more receive beams. For example, the CSI report may (for example, only) include the indication of the one or more random seed values. The network node 110 may use the one or more random seed values as inputs (for example, to an AI/ML model) to determine the one or more receive beams. For example, a receive beam identification algorithm may be executed by the network node 110 (for example, where the one or more random seed values are inputs to the receive beam identification algorithm).

In some aspects, in addition to the information associated with the one or more receive beams, the CSI report may include information associated with facilitating the beam predictions performed by the network node 110. For example, the CSI report may include one or more measurement values associated with at least one of the one or more CMRs (for example, measurement values obtained by the UE 120 based at least in part on performing the measurements). In some aspects, the UE 120 may include measurement values associated with a subset of CMRs from a set of configured CMRs for the CSI report. As another example, the UE 120 may include measurement values associated with all CMRs configured for the CSI report. Additionally or alternatively, the CSI report may include information associated with at least one receive beam, included in the one or more receive beams, used to measure the one or more measurement values (for example, parameters, similar to the parameters described above, associated with identifying the at least one receive beam). Additionally or alternatively, the CSI report may include an indication of the at least one receive beam (for example, an explicit indication of the at least one receive beam). In other words, the UE 120 may include, in the CSI report, information to indicate the receive beams actually used by the UE 120 to measure the report measurement values.

In a fourth operation 720, the network node 110 may identify the one or more receive beams indicated by the UE 120 (for example, indicated by the UE 120 in the third operation 715). For example, the network node 110 may identify the one or more receive beams based at least in part on explicit indications of the one or more receive beams (for example, identifiers included in the CSI report). Additionally or alternatively, the network node 110 may derive the one or more receive beams based at least in part on the one or more parameters indicated by the UE 120.

In some implementations, the network node 110 may use an AI/ML model to identify the one or more receive beams. For example, the AI/ML model may be trained to determine or predict receive beams based on an input (for example, an input of the one or more parameters described elsewhere herein). For example, the network node 110 may receive an indication of the trained AI/ML model (for example, from a server device). The network node 110 may provide, to the trained AI/ML model, an indication of the one or more parameters indicated by the UE 120. For example, the one or more parameters (for example, indicated by the CSI report, an RRC communication, a MAC-CE communication, and/or a UCI communication) may be inputs to a machine learning model associated with predicting the one or more receive beams. The trained AI/ML model may output an indication of the one or more receive beams. In some aspects, the inputs to the trained AI/ML model may include measurement values (for example, filtered measurement values) reported by the UE 120 (for example, in the CSI report). In some aspects, the input to the trained AI/ML model may include one or more random seed values reported by the UE 120. In such examples, the UE 120 may refrain from reporting indications of actually used receive beams for previous measurement occasions. For example, the network node 110 may be enabled to identify the receive beams (for example, using the AI/ML model). Therefore, to conserve signaling overhead, the UE 120 may refrain from including indications of the one or more receive beams in the CSI report (for example, based at least in part on the one or more parameters being inputs to the machine learning model).

In a fifth operation 725, the network node 110 may predict one or more measurement values associated with the one or more CMRs (for example, that are configured for the CSI report). For example, the network node 110 may provide, to an AI/ML model that is trained to predict measurement values (for example, similar to the AI/ML model 510), an input of the one or more receive beams (for example, and the respective CMRs associated with the one or more receive beams). For example, an input to the AI/ML model may be similar to the inputs described in connection with FIG. 6. In other words, by receiving the indication of the receive beams, the network node 110 may be enabled to identify receive-beam-CMR beam pairs to be used an inputs to the AI/ML model.

An output of the AI/ML model may be predicted instantaneous measurement values (for example, predicted L1-RSRP measurement values and/or predicted L1 signal-to-interference-plus-noise ratio (SINR) measurement values) for a given measurement occasion. In some aspects, the network node 110 may calculate one or more filtered measurement values for a given CMR based at least in part on one or more predicted measurement values for the given CMR (for example, in a similar manner as described in more detail elsewhere herein).

In some aspects, the network node 110 may transmit, and the UE 120 may receive, an indication of one or more predicted measurement values for respective CMRs from the set of CMRs associated with the CSI report. For example, the network node 110 may transmit, and the UE 120 may receive, an indication of one or more predicted measurement values and an indication of CMR-receive-beam pairs associated with the one or more predicted measurement values. The predicted measurement values may be used as an input by the UE 120 for selecting and/or predicting receive beams to be associated with respective CMRs for future time domain occasions or measurement occasions. For example, the UE 120 may predict at least one future receive beam to be associated with at least one channel measurement resource, from the one or more channel measurement resources, for another one or more future time domain occasions. The predicted measurement values may improve the receive beam selection performed by the UE 120 (for example, selection similar to the operations performed as part of the second operation 710). In some aspects, the network node 110 may transmit, and the UE 120 may receive, instantaneous predicted measurement values and/or filtered measurement values for a given CMR.

In some aspects, the network node 110 may identify a best receive beam to be associated with a given CMR based at least in part on the predicted measurement values and/or the filtered measurement values. For example, the network node 110 may identify a receive beam of the UE 120 that is associated with a highest filtered measurement value for a given CMR. For example, when the beam measurement prediction is performed by the network node 110 as described herein, the UE 120 may be unaware of a best receive beam for a given CMR (for example, because the UE 120 does not perform the measurements and/or predictions for the given CMR). In some aspects, the network node 110 may transmit, and the UE 120 may receive, an indication of the best receive beam associated with a given CMR.

In some aspects, in a sixth operation 730, the network node 110 may transmit, and the UE 120 may receive, an indication of a transmission configuration indicator (TCI) state associated with a CMR from the one or more channel measurement resources. The TCI state may include an indication of a receive beam, from the one or more receive beams, to be associated with the TCI state. For example, the CMR may be a QCL source reference for the TCI state (for example, a Type-D QCL source resource, as defined or otherwise fixed by a wireless communication standard, such as the 3GPP). The receive beam may be a best receive beam associated with the CMR as determined by the network node 110. For example, in the sixth operation 730, the network node 110 may transmit a MAC-CE communication that activates the TCI state. The MAC-CE communication may include the indication of the receive beam associated with the TCI state. As another example, in the sixth operation 730, the network node 110 may transmit a DCI communication indicating the TCI state. The DCI communication may include the indication of the receive beam associated with the TCI state (for example, indicating that the UE 120 is to switch to using the TCI state). For example, the DCI may be associated with a DCI format that is associated with indicating receive beam information (for example, receive beam information of the UE 120) and/or with a radio network temporary identifier (RNTI) that is associated with indicating receive beam information (for example, receive beam information of the UE 120). The UE 120 may receive one or more signals (for example, one or more physical downlink shared channel (PDSCH) signals) that are associated with the TCI state using the receive beam indicated by the network node 110.

As a result, the operations described herein can be used to conserve a complexity and/or processing overhead that would have otherwise been used by the UE 120 to predict measurement values for the set of CMRs. For example, transmitting the indication of the one or more receive beams to the network node 110 may enable the network node 110 to identify inputs to be provided to the AI/ML model. This may enable the network node 110 to deploy the AI/ML model for predicting measurement values associated with the UE 120 (for example, using receive beam information associated with the UE 120). As a result, the network node 110 may obtain predicted beam measurements associated with the UE 120 (for example, using receive beam information associated with the UE 120) while also conserving processing resources and/or power resources of the UE 120 that would have otherwise been used by the UE 120 to predict the beam measurements.

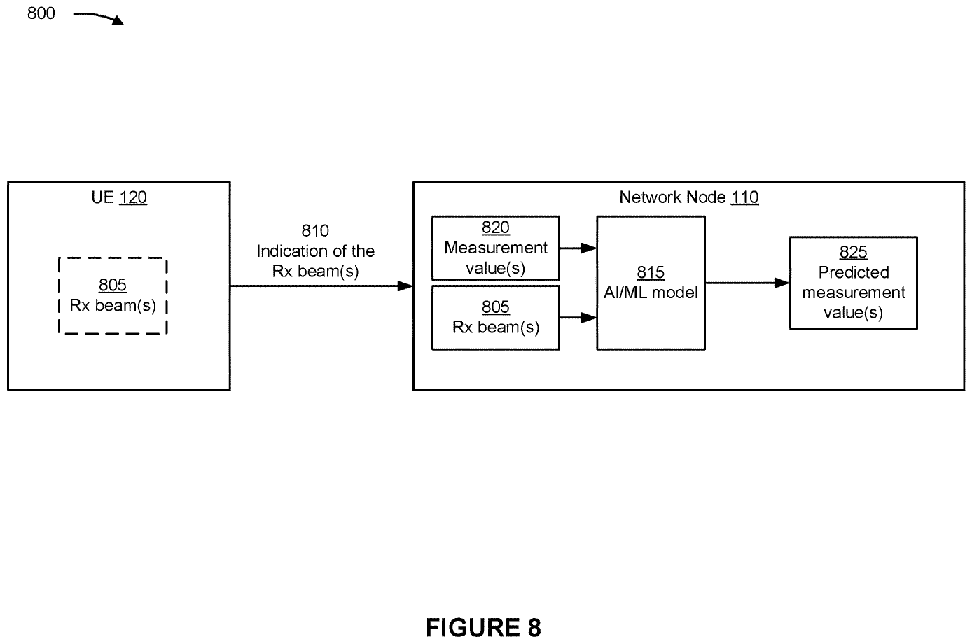

FIG. 8 is a diagram of an example associated with beam pair reporting for predicted beam measurements 800 in accordance with the present disclosure. As shown in FIG. 8, the network node 110 may communicate with the UE 120 (for example, in a similar manner as described in connection with FIG. 7).

As shown in FIG. 8, the UE 120 may select one or more receive beams 805. For example, the UE 120 may select the one or more receive beams in a similar manner as described in connection with the second operation 710. For example, the UE 120 may select a receive beam for each CMR included in a set of CMRs (for example, for one or more future measurement occasions). In a first operation 810, the UE 120 may transmit, and the network node 110 may receive, an indication of the one or more receive beams 805. For example, the indication of the one or more receive beams 805 may be included in a CSI report. Additionally or alternatively, the indication of the one or more receive beams 805 may be included in an RRC communication, a MAC-CE communication, and/or a UCI communication. For example, the UE 120 may transmit the indication of the one or more receive beams 805 in a similar manner as described in connection with the third operation 715.

The network node 110 may store an AI/ML model 815. The AI/ML model 815 may be trained to predict beam measurements. For example, the AI/ML model 815 may be, or may be similar to, the AI/ML model 510. As shown in FIG. 8, the network node may provide, as inputs to the AI/ML model 815, an indication of the one or more receive beams 805 and one or more measurement values 820. The one or more measurement values 820 may be L1-RSRP values and/or L1-SINR values received by the network node 110 from the UE 120. For example, the one or more measurement values 820 may be associated with previous measurement occasions. As shown in FIG. 8, an output of the AI/ML model 815 may include one or more predicted measurement values 825. For example, the one or more predicted measurement values 825 may include one or more predicted measurement values, for a future measurement occasion, for each CMR included in the set of CMRs. For example, the one or more predicted measurement values 825 may be instantaneous measurement values. In some aspects, the network node 110 may calculate a filtered measurement value, for a given CMR, based at least in part on one or more predicted measurement values (for example, from the one or more predicted measurement values 825) and/or one or more actual measurement values (for example, from the one or more measurement values 820).

FIG. 9 is a flowchart illustrating an example process 900 performed, for example, by a UE that supports beam pair reporting for predicted beam measurements in accordance with the present disclosure. Example process 900 is an example where the UE (for example, UE 120) performs operations associated with beam pair reporting for predicted beam measurements.

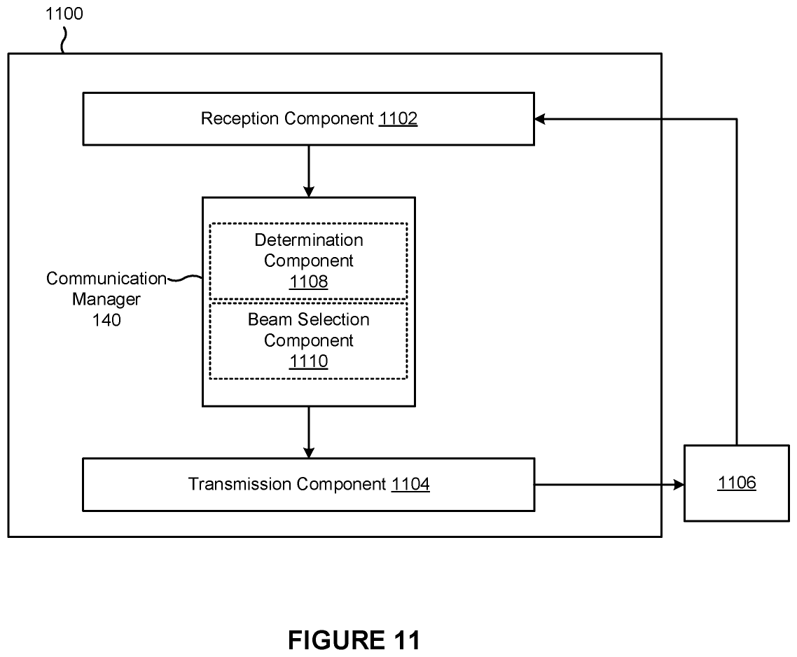

As shown in FIG. 9, in some aspects, process 900 may include receiving, from a network node, an indication to transmit a CSI report associated with one or more channel measurement resources (block 910). For example, the UE (such as by using communication manager 140 or reception component 1102, depicted in FIG. 11) may receive, from a network node, an indication to transmit a CSI report associated with one or more channel measurement resources, as described above.

As further shown in FIG. 9, in some aspects, process 900 may include transmitting, to the network node, the CSI report including an indication of information associated with one or more receive beams that are associated with respective channel measurement resources from the one or more channel measurement resources for one or more future time domain occasions, the information including at least one of: one or more parameters associated with identifying the one or more receive beams, or an indication of the one or more receive beams (block 920). For example, the UE (such as by using communication manager 140 or transmission component 1104, depicted in FIG. 11) may transmit, to the network node, the CSI report including an indication of information associated with one or more receive beams that are associated with respective channel measurement resources from the one or more channel measurement resources for one or more future time domain occasions, the information including at least one of: one or more parameters associated with identifying the one or more receive beams, or an indication of the one or more receive beams, as described above.

Process 900 may include additional aspects, such as any single aspect or any combination of aspects described below or in connection with one or more other processes described elsewhere herein.

In a first additional aspect, the one or more receive beams include at least one of one or more beams used by the UE to receive at least one channel measurement resource from the one or more channel measurement resources, or a virtual beam that is predicted to be associated with at least one channel measurement resource from the one or more channel measurement resources.

In a second additional aspect, alone or in combination with the first aspect, the information is associated with facilitating beam measurement predictions.

In a third additional aspect, alone or in combination with one or more of the first and second aspects, the CSI report includes an indication of at least one of one or more measurement values associated with at least one of the one or more channel measurement resources, information associated with at least one receive beam, included in the one or more receive beams, used to measure the one or more measurement values, or an indication of the at least one receive beam.

In a fourth additional aspect, alone or in combination with one or more of the first through third aspects, the one or more parameters include at least one of a location of one or more antenna modules, an orientation of the one or more antenna modules, codebook information, an automatic gain control operation status, or one or more thermal parameters.

In a fifth additional aspect, alone or in combination with one or more of the first through fourth aspects, the one or more parameters are included in at least one of an RRC communication, a MAC-CE communication, or a UCI communication.

In a sixth additional aspect, alone or in combination with one or more of the first through fifth aspects, the one or more parameters are inputs to a machine learning model associated with predicting the one or more receive beams.

In a seventh additional aspect, alone or in combination with one or more of the first through sixth aspects, process 900 includes refraining from including the indication of the one or more receive beams in the CSI report based at least in part on the one or more parameters being inputs to the machine learning model.

In an eighth additional aspect, alone or in combination with one or more of the first through seventh aspects, process 900 includes selecting at least one receive beam, from the one or more receive beams, to be associated with at least one channel measurement resource, from the one or more channel measurement resources, for the one or more future time domain occasions, where the CSI report includes an indication of the at least one receive beam.

In a ninth additional aspect, alone or in combination with one or more of the first through eighth aspects, the one or more parameters include one or more random seed values associated with identifying the one or more receive beams.

In a tenth additional aspect, alone or in combination with one or more of the first through ninth aspects, process 900 includes receiving, from the network node, an indication of one or more predicted measurement values and an indication of channel measurement resource-receive beam pairs associated with the one or more predicted measurement values, and predicting at least one future receive beam to be associated with at least one channel measurement resource, from the one or more channel measurement resources, for another one or more future time domain occasions.

In an eleventh additional aspect, alone or in combination with one or more of the first through tenth aspects, process 900 includes receiving, from the network node, an indication of a TCI state associated with a channel measurement resource from the one or more channel measurement resources, the TCI state including an indication of a receive beam, from the one or more receive beams, to be associated with the TCI state.

Although FIG. 9 shows example blocks of process 900, in some aspects, process 900 may include additional blocks, fewer blocks, different blocks, or differently arranged blocks than those depicted in FIG. 9. Additionally or alternatively, two or more of the blocks of process 900 may be performed in parallel.

FIG. 10 is a flowchart illustrating an example process 1000 performed, for example, by a network node that supports beam pair reporting for predicted beam measurements in accordance with the present disclosure. Example process 1000 is an example where the network node (for example, network node 110) performs operations associated with beam pair reporting for predicted beam measurements.

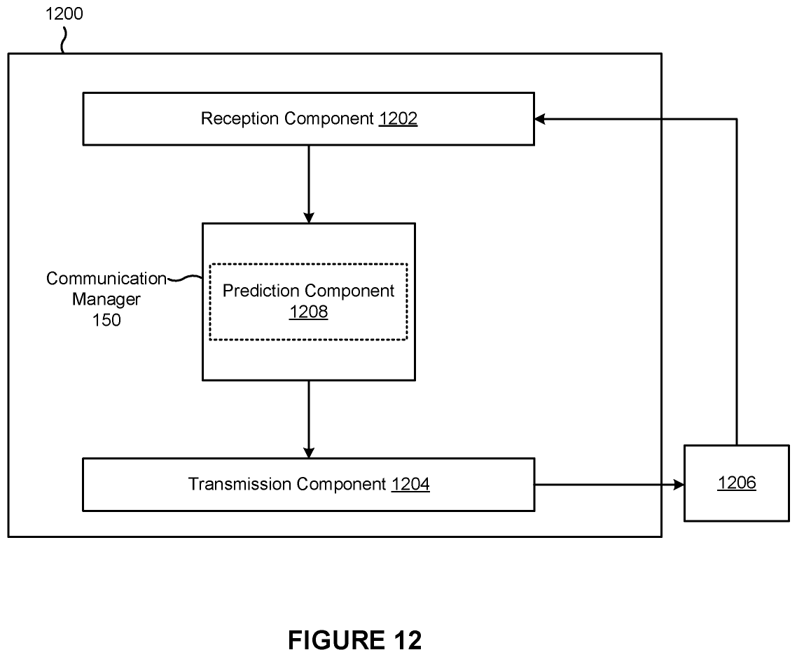

As shown in FIG. 10, in some aspects, process 1000 may include transmitting an indication for a UE to transmit a CSI report associated with one or more channel measurement resources (block 1010). For example, the network node (such as by using communication manager 150 or transmission component 1204, depicted in FIG. 12) may transmit an indication for a UE to transmit a CSI report associated with one or more channel measurement resources, as described above.

As further shown in FIG. 10, in some aspects, process 1000 may include receiving the CSI report, associated with the UE, including an indication of information associated with one or more receive beams, associated with the UE, that are associated with respective channel measurement resources from the one or more channel measurement resources for one or more future time domain occasions, the information including at least one of: one or more parameters associated with identifying the one or more receive beams, or an indication of the one or more receive beams (block 1020). For example, the network node (such as by using communication manager 150 or reception component 1202, depicted in FIG. 12) may receive the CSI report, associated with the UE, including an indication of information associated with one or more receive beams, associated with the UE, that are associated with respective channel measurement resources from the one or more channel measurement resources for one or more future time domain occasions, the information including at least one of: one or more parameters associated with identifying the one or more receive beams, or an indication of the one or more receive beams, as described above.

Process 1000 may include additional aspects, such as any single aspect or any combination of aspects described below or in connection with one or more other processes described elsewhere herein.

In a first additional aspect, the one or more receive beams include at least one of one or more beams used by the UE to receive at least one channel measurement resource from the one or more channel measurement resources, or a virtual beam that is predicted to be associated with at least one channel measurement resource from the one or more channel measurement resources.

In a second additional aspect, alone or in combination with the first aspect, the information is associated with facilitating beam measurement predictions.

In a third additional aspect, alone or in combination with one or more of the first and second aspects, process 1000 includes predicting one or more beam measurement predictions based at least in part on the information associated with the one or more receive beams.

In a fourth additional aspect, alone or in combination with one or more of the first through third aspects, the CSI report includes an indication of at least one of one or more measurement values associated with at least one of the one or more channel measurement resources, information associated with at least one receive beam, included in the one or more receive beams, used to measure the one or more measurement values, or an indication of the at least one receive beam.

In a fifth additional aspect, alone or in combination with one or more of the first through fourth aspects, the one or more parameters include at least one of a location of one or more antenna modules, an orientation of the one or more antenna modules, codebook information, an automatic gain control operation status, or one or more thermal parameters.

In a sixth additional aspect, alone or in combination with one or more of the first through fifth aspects, the one or more parameters are included in at least one of an RRC communication, a MAC-CE communication, or a UCI communication.

In a seventh additional aspect, alone or in combination with one or more of the first through sixth aspects, process 1000 includes predicting the one or more receive beams based at least in part on providing the one or more parameters as inputs to a machine learning model associated with predicting the one or more receive beams, where an output of the machine learning model included a prediction of the one or more receive beams.

In an eighth additional aspect, alone or in combination with one or more of the first through seventh aspects, the one or more parameters include one or more random seed values associated with identifying the one or more receive beams.

In a ninth additional aspect, alone or in combination with one or more of the first through eighth aspects, process 1000 includes transmitting an indication of one or more predicted measurement values and an indication of channel measurement resource-receive beam pairs associated with the one or more predicted measurement values.

In a tenth additional aspect, alone or in combination with one or more of the first through ninth aspects, process 1000 includes predicting, based at least in part on the information associated with the one or more receive beams, a receive beam to be associated with a channel measurement resource from the one or more channel measurement resources, and transmitting an indication of a TCI state associated with the channel measurement resource, the TCI state including an indication of the receive beam to be associated with the TCI state.

Although FIG. 10 shows example blocks of process 1000, in some aspects, process 1000 may include additional blocks, fewer blocks, different blocks, or differently arranged blocks than those depicted in FIG. 10. Additionally or alternatively, two or more of the blocks of process 1000 may be performed in parallel.

FIG. 11 is a diagram of an example apparatus 1100 for wireless communication that supports beam pair reporting for predicted beam measurements in accordance with the present disclosure. The apparatus 1100 may be a UE, or a UE may include the apparatus 1100. In some aspects, the apparatus 1100 includes a reception component 1102, a transmission component 1104, and a communication manager 140, which may be in communication with one another (for example, via one or more buses). As shown, the apparatus 1100 may communicate with another apparatus 1106 (such as a UE, a network node, or another wireless communication device) using the reception component 1102 and the transmission component 1104.

In some aspects, the apparatus 1100 may be configured to perform one or more operations described herein in connection with FIGS. 7 and 8. Additionally or alternatively, the apparatus 1100 may be configured to perform one or more processes described herein, such as process 900 of FIG. 9. In some aspects, the apparatus 1100 may include one or more components of the UE described above in connection with FIG. 2.

The reception component 1102 may receive communications, such as reference signals, control information, and/or data communications, from the apparatus 1106. The reception component 1102 may provide received communications to one or more other components of the apparatus 1100, such as the communication manager 140. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1102 may include one or more antennas, a modem, a demodulator, a MIMO detector, a receive processor, a controller/processor, and/or a memory of the UE described above in connection with FIG. 2.

The transmission component 1104 may transmit communications, such as reference signals, control information, and/or data communications, to the apparatus 1106. In some aspects, the communication manager 140 may generate communications and may transmit the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, and/or a memory of the UE described above in connection with FIG. 2. In some aspects, the transmission component 1104 may be co-located with the reception component 1102 in a transceiver.

The communication manager 140 may receive or may cause the reception component 1102 to receive, from a network node, an indication to transmit a CSI report associated with one or more channel measurement resources. The communication manager 140 may transmit or may cause the transmission component 1104 to transmit, to the network node, the CSI report including an indication of information associated with one or more receive beams that are associated with respective channel measurement resources from the one or more channel measurement resources for one or more future time domain occasions, the information including at least one of: one or more parameters associated with identifying the one or more receive beams, or an indication of the one or more receive beams. In some aspects, the communication manager 140 may perform one or more operations described elsewhere herein as being performed by one or more components of the communication manager 140.

The communication manager 140 may include a controller/processor, a memory, t of the UE described above in connection with FIG. 2. In some aspects, the communication manager 140 includes a set of components, such as a determination component 1108, and/or a beam selection component 1110, among other examples.

Alternatively, the set of components may be separate and distinct from the communication manager 140. In some aspects, one or more components of the set of components may include or may be implemented within a controller/processor, a memory, t of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive, from a network node, an indication to transmit a CSI report associated with one or more channel measurement resources. The transmission component 1104 may transmit, to the network node, the CSI report including an indication of information associated with one or more receive beams that are associated with respective channel measurement resources from the one or more channel measurement resources for one or more future time domain occasions, the information including at least one of: one or more parameters associated with identifying the one or more receive beams, or an indication of the one or more receive beams.

The determination component 1108 may refrain from including the indication of the one or more receive beams in the CSI report based at least in part on the one or more parameters being inputs to the machine learning model.

The beam selection component 1110 may select at least one receive beam, from the one or more receive beams, to be associated with at least one channel measurement resource, from the one or more channel measurement resources, for the one or more future time domain occasions, wherein the CSI report includes an indication of the at least one receive beam.

The reception component 1102 may receive, from the network node, an indication of one or more predicted measurement values and an indication of channel measurement resource-receive beam pairs associated with the one or more predicted measurement values.

The beam selection component 1110 may predict at least one future receive beam to be associated with at least one channel measurement resource, from the one or more channel measurement resources, for another one or more future time domain occasions.

The reception component 1102 may receive, from the network node, an indication of a TCI state associated with a channel measurement resource from the one or more channel measurement resources, the TCI state including an indication of a receive beam, from the one or more receive beams, to be associated with the TCI state.

The quantity and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally or alternatively, a set of (one or more) components shown in FIG. 11 may perform one or more functions described as being performed by another set of components shown in FIG. 11.

FIG. 12 is a diagram of an example apparatus 1200 for wireless communication that supports beam pair reporting for predicted beam measurements in accordance with the present disclosure. The apparatus 1200 may be a network node, or a network node may include the apparatus 1200. In some aspects, the apparatus 1200 includes a reception component 1202, a transmission component 1204, and a communication manager 150, which may be in communication with one another (for example, via one or more buses). As shown, the apparatus 1200 may communicate with another apparatus 1206 (such as a UE, a network node, or another wireless communication device) using the reception component 1202 and the transmission component 1204.

In some aspects, the apparatus 1200 may be configured to perform one or more operations described herein in connection with FIGS. 7 and 8. Additionally or alternatively, the apparatus 1200 may be configured to perform one or more processes described herein, such as process 1000 of FIG. 10. In some aspects, the apparatus 1200 may include one or more components of the network node described above in connection with FIG. 2.

The reception component 1202 may receive communications, such as reference signals, control information, and/or data communications, from the apparatus 1206. The reception component 1202 may provide received communications to one or more other components of the apparatus 1200, such as the communication manager 150. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1202 may include one or more antennas, a modem, a demodulator, a MIMO detector, a receive processor, a controller/processor, and/or a memory of the network node described above in connection with FIG. 2.

The transmission component 1204 may transmit communications, such as reference signals, control information, and/or data communications, to the apparatus 1206. In some aspects, the communication manager 150 may generate communications and may transmit the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, and/or a memory of the network node described above in connection with FIG. 2. In some aspects, the transmission component 1204 may be co-located with the reception component 1202 in a transceiver.

The communication manager 150 may transmit or may cause the transmission component 1204 to transmit an indication for a UE to transmit a CSI report associated with one or more channel measurement resources. The communication manager 150 may receive or may cause the reception component 1202 to receive the CSI report, associated with the UE, including an indication of information associated with one or more receive beams, associated with the UE, that are associated with respective channel measurement resources from the one or more channel measurement resources for one or more future time domain occasions, the information including at least one of: one or more parameters associated with identifying the one or more receive beams, or an indication of the one or more receive beams. In some aspects, the communication manager 150 may perform one or more operations described elsewhere herein as being performed by one or more components of the communication manager 150.

The communication manager 150 may include a controller/processor, a memory, a scheduler, and/or a communication unit of the network node described above in connection with FIG. 2. In some aspects, the communication manager 150 includes a set of components, such as a prediction component 1208, among other examples. Alternatively, the set of components may be separate and distinct from the communication manager 150. In some aspects, one or more components of the set of components may include or may be implemented within a controller/processor, a memory, a scheduler, and/or a communication unit of the network node described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The transmission component 1204 may transmit an indication for a UE to transmit a CSI report associated with one or more channel measurement resources. The reception component 1202 may receive the CSI report, associated with the UE, including an indication of information associated with one or more receive beams, associated with the UE, that are associated with respective channel measurement resources from the one or more channel measurement resources for one or more future time domain occasions, the information including at least one of: one or more parameters associated with identifying the one or more receive beams, or an indication of the one or more receive beams.

The prediction component 1208 may predict one or more beam measurement predictions based at least in part on the information associated with the one or more receive beams.

The prediction component 1208 may predict the one or more receive beams based at least in part on providing the one or more parameters as inputs to a machine learning model associated with predicting the one or more receive beams, wherein an output of the machine learning model included a prediction of the one or more receive beams.

The transmission component 1204 may transmit an indication of one or more predicted measurement values and an indication of channel measurement resource-receive beam pairs associated with the one or more predicted measurement values.

The prediction component 1208 may predict, based at least in part on the information associated with the one or more receive beams, a receive beam to be associated with a channel measurement resource from the one or more channel measurement resources.

The transmission component 1204 may transmit an indication of a TCI state associated with the channel measurement resource, the TCI state including an indication of the receive beam to be associated with the TCI state.

The quantity and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving, from a network node, an indication to transmit a channel state information (CSI) report associated with one or more channel measurement resources; and transmitting, to the network node, the CSI report including an indication of information associated with one or more receive beams that are associated with respective channel measurement resources from the one or more channel measurement resources for one or more future time domain occasions, the information including at least one of: one or more parameters associated with identifying the one or more receive beams, or an indication of the one or more receive beams.

Aspect 2: The method of Aspect 1, wherein the one or more receive beams include at least one of one or more beams used by the UE to receive at least one channel measurement resource from the one or more channel measurement resources, or a virtual beam that is predicted to be associated with at least one channel measurement resource from the one or more channel measurement resources.

Aspect 3: The method of any of Aspects 1-2, wherein the information is associated with facilitating beam measurement predictions.

Aspect 4: The method of any of Aspects 1-3, wherein the CSI report includes an indication of at least one of: one or more measurement values associated with at least one of the one or more channel measurement resources, information associated with at least one receive beam, included in the one or more receive beams, used to measure the one or more measurement values, or an indication of the at least one receive beam. one or more measurement values associated with at least one of the one or more channel measurement resources, information associated with at least one receive beam, included in the one or more receive beams, used to measure the one or more measurement values, or an indication of the at least one receive beam.

Aspect 5: The method of any of Aspects 1-4, wherein the one or more parameters include at least one of: a location of one or more antenna modules, an orientation of the one or more antenna modules, codebook information, an automatic gain control operation status, or one or more thermal parameters.

Aspect 6: The method of any of Aspects 1-5, wherein the one or more parameters are included in at least one of a radio resource control (RRC) communication, a medium access control (MAC) control element (MAC-CE) communication, or an uplink control information (UCI) communication.

Aspect 7: The method of any of Aspects 1-6, wherein the one or more parameters are inputs to a machine learning model associated with predicting the one or more receive beams.

Aspect 8: The method of Aspect 7, further comprising: refraining from including the indication of the one or more receive beams in the CSI report based at least in part on the one or more parameters being inputs to the machine learning model.

Aspect 9: The method of any of Aspects 1-8, further comprising: select at least one receive beam, from the one or more receive beams, to be associated with at least one channel measurement resource, from the one or more channel measurement resources, for the one or more future time domain occasions, wherein the CSI report includes an indication of the at least one receive beam.

Aspect 10: The method of any of Aspects 1-9, wherein the one or more parameters include one or more random seed values associated with identifying the one or more receive beams.

Aspect 11: The method of any of Aspects 1-10, further comprising: receiving, from the network node, an indication of one or more predicted measurement values and an indication of channel measurement resource-receive beam pairs associated with the one or more predicted measurement values; and predicting at least one future receive beam to be associated with at least one channel measurement resource, from the one or more channel measurement resources, for another one or more future time domain occasions.

Aspect 12: The method of any of Aspects 1-11, further comprising: receiving, from the network node, an indication of a transmission configuration indicator (TCI) state associated with a channel measurement resource from the one or more channel measurement resources, the TCI state including an indication of a receive beam, from the one or more receive beams, to be associated with the TCI state.

Aspect 13: A method of wireless communication performed by a network node, comprising: transmitting an indication for a user equipment (UE) to transmit a channel state information (CSI) report associated with one or more channel measurement resources; and receiving the CSI report, associated with the UE, including an indication of information associated with one or more receive beams, associated with the UE, that are associated with respective channel measurement resources from the one or more channel measurement resources for one or more future time domain occasions, the information including at least one of: one or more parameters associated with identifying the one or more receive beams, or an indication of the one or more receive beams.

Aspect 14: The method of Aspect 13, wherein the one or more receive beams include at least one of one or more beams used by the UE to receive at least one channel measurement resource from the one or more channel measurement resources, or a virtual beam that is predicted to be associated with at least one channel measurement resource from the one or more channel measurement resources.

Aspect 15: The method of any of Aspects 13-14, wherein the information is associated with facilitating beam measurement predictions.

Aspect 16: The method of any of Aspects 13-15, further comprising: predicting one or more beam measurement predictions based at least in part on the information associated with the one or more receive beams.

Aspect 17: The method of any of Aspects 13-16, wherein the CSI report includes an indication of at least one of: one or more measurement values associated with at least one of the one or more channel measurement resources, information associated with at least one receive beam, included in the one or more receive beams, used to measure the one or more measurement values, or an indication of the at least one receive beam. one or more measurement values associated with at least one of the one or more channel measurement resources, information associated with at least one receive beam, included in the one or more receive beams, used to measure the one or more measurement values, or an indication of the at least one receive beam.

Aspect 18: The method of any of Aspects 13-17, wherein the one or more parameters include at least one of: a location of one or more antenna modules, an orientation of the one or more antenna modules, codebook information, an automatic gain control operation status, or one or more thermal parameters.

Aspect 19: The method of any of Aspects 13-18, wherein the one or more parameters are included in at least one of a radio resource control (RRC) communication, a medium access control (MAC) control element (MAC-CE) communication, or an uplink control information (UCI) communication.

Aspect 20: The method of any of Aspects 13-19, further comprising: predicting the one or more receive beams based at least in part on providing the one or more parameters as inputs to a machine learning model associated with predicting the one or more receive beams, wherein an output of the machine learning model included a prediction of the one or more receive beams.

Aspect 21: The method of any of Aspects 13-20, wherein the one or more parameters include one or more random seed values associated with identifying the one or more receive beams.

Aspect 22: The method of any of Aspects 13-21, further comprising: transmitting an indication of one or more predicted measurement values and an indication of channel measurement resource-receive beam pairs associated with the one or more predicted measurement values.

Aspect 23: The method of any of Aspects 13-22, further comprising: predicting, based at least in part on the information associated with the one or more receive beams, a receive beam to be associated with a channel measurement resource from the one or more channel measurement resources; and transmitting an indication of a transmission configuration indicator (TCI) state associated with the channel measurement resource, the TCI state including an indication of the receive beam to be associated with the TCI state.

Aspect 24: An apparatus for wireless communication at a device, comprising a processor; memory coupled with the processor; and instructions stored in the memory and executable by the processor to cause the apparatus to perform the method of one or more of Aspects 1-12.

Aspect 25: A device for wireless communication, comprising a memory and one or more processors coupled to the memory, the one or more processors configured to perform the method of one or more of Aspects 1-12.

Aspect 26: An apparatus for wireless communication, comprising at least one means for performing the method of one or more of Aspects 1-12.

Aspect 27: A non-transitory computer-readable medium storing code for wireless communication, the code comprising instructions executable by a processor to perform the method of one or more of Aspects 1-12.

Aspect 28: A non-transitory computer-readable medium storing a set of instructions for wireless communication, the set of instructions comprising one or more instructions that, when executed by one or more processors of a device, cause the device to perform the method of one or more of Aspects 1-12.

Aspect 29: An apparatus for wireless communication at a device, comprising a processor; memory coupled with the processor; and instructions stored in the memory and executable by the processor to cause the apparatus to perform the method of one or more of Aspects 13-23.

Aspect 30: A device for wireless communication, comprising a memory and one or more processors coupled to the memory, the one or more processors configured to perform the method of one or more of Aspects 13-23.

Aspect 31: An apparatus for wireless communication, comprising at least one means for performing the method of one or more of Aspects 13-23.

Aspect 32: A non-transitory computer-readable medium storing code for wireless communication, the code comprising instructions executable by a processor to perform the method of one or more of Aspects 13-23.

Aspect 33: A non-transitory computer-readable medium storing a set of instructions for wireless communication, the set of instructions comprising one or more instructions that, when executed by one or more processors of a device, cause the device to perform the method of one or more of Aspects 13-23.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

1. A user equipment (UE) for wireless communication, comprising:
at least one memory; and
at least one processor communicatively coupled with the at least one memory, the at least one processor operable to cause the UE to:
receive, from a network node, an indication to transmit a channel state information (CSI) report associated with one or more channel measurement resources; and
transmit, to the network node, the CSI report including an indication of information associated with one or more receive beams that are associated with respective channel measurement resources from the one or more channel measurement resources for one or more future time domain occasions, the information including at least one of: one or more parameters associated with identifying the one or more receive beams, or an indication of the one or more receive beams.

2. The UE of claim 1, wherein the one or more receive beams include at least one of one or more beams used by the UE to receive at least one channel measurement resource from the one or more channel measurement resources, or a virtual beam that is predicted to be associated with at least one channel measurement resource from the one or more channel measurement resources.

3. The UE of claim 1, wherein the CSI report includes an indication of at least one of:
one or more measurement values associated with at least one of the one or more channel measurement resources,
information associated with at least one receive beam, included in the one or more receive beams, used to measure the one or more measurement values, or
an indication of the at least one receive beam.

4. The UE of claim 1, wherein the one or more parameters include at least one of:
a location of one or more antenna modules,
an orientation of the one or more antenna modules,
codebook information,
an automatic gain control operation status, or
one or more thermal parameters.

5. The UE of claim 1, wherein the one or more parameters are included in at least one of a radio resource control (RRC) communication, a medium access control (MAC) control element (MAC-CE) communication, or an uplink control information (UCI) communication.

6. The UE of claim 1, wherein the one or more parameters are inputs to a machine learning model associated with predicting the one or more receive beams.

7. The UE of claim 6, wherein the at least one processor is further operable to cause the UE to:
refrain from including the indication of the one or more receive beams in the CSI report based at least in part on the one or more parameters being inputs to the machine learning model.

8. The UE of claim 1, wherein the at least one processor is further operable to cause the UE to:
select at least one receive beam, from the one or more receive beams, to be associated with at least one channel measurement resource, from the one or more channel measurement resources, for the one or more future time domain occasions, wherein the CSI report includes an indication of the at least one receive beam.

9. The UE of claim 1, wherein the one or more parameters include one or more random seed values associated with identifying the one or more receive beams.

10. The UE of claim 1, wherein the at least one processor is further operable to cause the UE to:
receive, from the network node, an indication of one or more predicted measurement values and an indication of channel measurement resource-receive beam pairs associated with the one or more predicted measurement values; and
predict at least one future receive beam to be associated with at least one channel measurement resource, from the one or more channel measurement resources, for another one or more future time domain occasions.

11. The UE of claim 1, wherein the at least one processor is further operable to cause the UE to:
receive, from the network node, an indication of a transmission configuration indicator (TCI) state associated with a channel measurement resource from the one or more channel measurement resources, the TCI state including an indication of a receive beam, from the one or more receive beams, to be associated with the TCI state.

12. A network node for wireless communication, comprising:
at least one memory; and
at least one processor communicatively coupled with the at least one memory, the at least one processor operable to cause the network node to:
transmit an indication for a user equipment (UE) to transmit a channel state information (CSI) report associated with one or more channel measurement resources; and
receive the CSI report, associated with the UE, including an indication of information associated with one or more receive beams, associated with the UE, that are associated with respective channel measurement resources from the one or more channel measurement resources for one or more future time domain occasions, the information including at least one of: one or more parameters associated with identifying the one or more receive beams, or an indication of the one or more receive beams.

13. The network node of claim 12, wherein the CSI report includes an indication of at least one of:
one or more measurement values associated with at least one of the one or more channel measurement resources,
information associated with at least one receive beam, included in the one or more receive beams, used to measure the one or more measurement values, or
an indication of the at least one receive beam.

14. The network node of claim 12, wherein the at least one processor is further operable to cause the network node to:
predict the one or more receive beams based at least in part on providing the one or more parameters as inputs to a machine learning model associated with predicting the one or more receive beams, wherein an output of the machine learning model included a prediction of the one or more receive beams.

15. The network node of claim 12, wherein the at least one processor is further operable to cause the network node to:
predict, based at least in part on the information associated with the one or more receive beams, a receive beam to be associated with a channel measurement resource from the one or more channel measurement resources; and
transmit an indication of a transmission configuration indicator (TCI) state associated with the channel measurement resource, the TCI state including an indication of the receive beam to be associated with the TCI state.

16. A method of wireless communication performed by a user equipment (UE), comprising:
receiving, from a network node, an indication to transmit a channel state information (CSI) report associated with one or more channel measurement resources; and
transmitting, to the network node, the CSI report including an indication of information associated with one or more receive beams that are associated with respective channel measurement resources from the one or more channel measurement resources for one or more future time domain occasions, the information including at least one of: one or more parameters associated with identifying the one or more receive beams, or an indication of the one or more receive beams.

17. The method of claim 16, wherein the one or more receive beams include at least one of one or more beams used by the UE to receive at least one channel measurement resource from the one or more channel measurement resources, or a virtual beam that is predicted to be associated with at least one channel measurement resource from the one or more channel measurement resources.

18. The method of claim 16, wherein the CSI report includes an indication of at least one of:
one or more measurement values associated with at least one of the one or more channel measurement resources,
information associated with at least one receive beam, included in the one or more receive beams, used to measure the one or more measurement values, or
an indication of the at least one receive beam.

19. The method of claim 16, wherein the one or more parameters include at least one of:
a location of one or more antenna modules,
an orientation of the one or more antenna modules,
codebook information,
an automatic gain control operation status, or
one or more thermal parameters.

20-26. (canceled)

27. A method of wireless communication performed by a network node, comprising:
transmitting an indication for a user equipment (UE) to transmit a channel state information (CSI) report associated with one or more channel measurement resources; and
receiving the CSI report, associated with the UE, including an indication of information associated with one or more receive beams, associated with the UE, that are associated with respective channel measurement resources from the one or more channel measurement resources for one or more future time domain occasions, the information including at least one of: one or more parameters associated with identifying the one or more receive beams, or an indication of the one or more receive beams.

28-30. (canceled)
